(19) United States
(12) Patent Application Publication
(10) Pub. No.: US 2025/0213068 A1
(43) Pub. Date: Jul. 3, 2025

(54) OUTDOOR COOKING STATION WITH MULTIPLE INDEPENDENT COOKING MODES AND METHOD THEREOF

(71) Applicant: North Atlantic Imports, LLC, Logan, UT (US)

(72) Inventors: Roger Dahle, Providence, UT (US); Steve L. Puertas, Providence, UT (US); James C. Bush, III, Providence, UT (US); Christian S. Elkins, Hyrum, UT (US)

(21) Appl. No.: 18/972,965

(22) Filed: Dec. 7, 2024

Related U.S. Application Data
(63) Continuation-in-part of application No. 17/887,024, filed on Aug. 12, 2022.
Application No. 17/887,024 is a continuation-in-part of application No. 17/407,704, filed on Aug. 20, 2021, now Pat. No. 11,700,971.
Application No. 17/407,704 is a continuation of application No. 16/428,605, filed on May 31, 2019, now Pat. No. 11,116,360.
(60) Provisional application No. 63/607,989, filed on Dec. 8, 2023.
(60) Provisional application No. 63/232,630, filed on Aug. 12, 2021.
(60) Provisional application No. 62/678,436, filed on May 31, 2018.

(51) Int. Cl. A47J 37/07; A23B 4/052; A23L 5/10; A47J 37/06

(52) U.S. Cl. CPC A47J 37/0713; A23B 4/052; A23L 5/15; A47J 37/0682; A47J 37/0709; A23V 2002/00

(57) ABSTRACT

An outdoor cooking station configured to simultaneously and independently cook food with separate cooking modes. The cooking station includes a main body extending to define a smoker chamber and a separate air fryer chamber. The smoker chamber is heated with smoke from igniting and burning pellets and the air fryer chamber is heated with an electrical heating element and a fan for mixing the air therein. In one embodiment, the cooking station includes a motor fan that draws smoke from the smoker chamber to the air fryer chamber with ducting therebetween. With this arrangement, the cooking station provides different cooking chambers dedicated for cooking food independent of each other as well as a secondary chamber or the air fryer chamber being employed for cold smoking food items or the option to provide smoke to the air fryer chamber while air frying the food therein.

### CROSS-REFERENCE TO RELATED APPLICATIONS

This application claims the benefit of U.S. Provisional Application No. 63/607,989, filed Dec. 8, 2023, the disclosure of which is hereby incorporated by reference herein in its entirety. Further, this application is a continuation-in-part of U.S. patent application Ser. No. 17/887,024, filed Aug. 12, 2022, which claims the benefit of U.S. Provisional Application No. 63/232,630, filed Aug. 12, 2021, the disclosures of which are hereby incorporated by reference herein in its entirety. Further, U.S. patent application Ser. No. 17/887,024 is a continuation-in-part of U.S. patent application Ser. No. 17/407,704, filed Aug. 20, 2021, now U.S. Pat. No. 11,700,971, which is a continuation of U.S. patent application Ser. No. 16/428,605, filed May 31, 2019, now U.S. Pat. No. 11,116,360, which claims the benefit of U.S. Provisional Application No. 62/678,436, filed May 31, 2018, the disclosures of which are hereby incorporated by reference herein in their entirety.

### TECHNICAL FIELD

The present invention relates generally to outdoor type cooking stations and, more specifically, the present invention relates to independent cooking modes within a single stand-alone outdoor cooking station.

### BACKGROUND

Barbequing has become a popular and pervasive tradition in much of the world. A barbeque grill is a device for cooking food by applying heat directly below a grill. There are several varieties of grills but most fall into one of two categories, either gas fueled or charcoal. Gas fueled grills typically use propane or natural gas as a fuel source, with the gas flame either cooking the food directly or heating grilling elements which in turn radiate the heat necessary to cook the food. As such, grilling has become a popular method of cooking food due to the unique flavors and texture imparted to the food during the grilling process.

Another form of grilling that imparts unique flavors and texture to food is by employing a griddle. The griddle is a cooking device consisting of a broad flat surface that can be heated over, for example, a gas fueled open flame and is used in both residential and commercial applications. The griddle is most commonly a flat metal plate composed of cast or wrought iron, aluminum or carbon steel.

Further, another mode of grilling that imparts unique flavors to food is grilling with a smoker device. The smoker device uses pellets as a fuel source and, as the pellets are burned, the pellets provide heated smoke to a substantially enclosed chamber to impart flavor to the food through the cooking process. Those desiring to cook food with a smoker device and a griddle or grilling barbeque station are often limited by the space available on their back patio or deck and, therefore, will likely only choose one or the other type of cooking stations in order to enjoy barbequing their food. Other distinct modes for cooking food in the outdoors is by baking food with, for example, a pizza oven or by air frying food.

### BRIEF SUMMARY OF THE INVENTION

The present invention is directed to various embodiments of an outdoor cooking station configured to independently cook food with different cooking modes and with separate fuel sources, one of the cooking modes configured to burn pellet elements to produce heated smoke. In one embodiment, the outdoor cooking station includes a main body and a pellet feeder system. The main body extends to define a first cooking portion and a second cooking portion for cooking in the different cooking modes, the first cooking portion and the second cooking portion being separate so as to be configured to be dedicated to cooking food simultaneously and independent of each other with the different cooking modes. The first cooking portion includes a smoker chamber with a grill cooking surface suspended therein, and including a pellet burner element positioned below the smoker chamber and configured to supply heated smoke to the smoker chamber. The second cooking portion of the main body extends to define an air frying chamber, the air frying chamber being accessible with a removable insert having a basket therewith such that the basket is sized to be positioned within the air frying chamber. The second cooking portion including a heating element and a fan positioned adjacent the heating element, the fan configured to move air over the heating element to mix air within the air frying chamber to facilitate cooking food placed within the basket of the insert. The pellet feeder system is coupled to the first cooking portion of the main body, the pellet feeder system including a hopper and a feeder. The hopper defines an opening adjacent a lower end of the hopper and the hopper is configured to hold the pellet elements. The feeder is positioned adjacent the opening defined in the hopper such that the feeder is configured to rotate so as to deliver the pellet elements from the opening defined in the hopper to a pellet cup so that the pellet elements are positioned adjacent the pellet burner element of the first cooking portion of the main body.

In another embodiment, the pellet burner element of the first cooking portion includes an electrical heating element positioned within the pellet cup sized and configured to ignite pellet elements with a fan positioned adjacent the feeder to further ignite the pellet elements. In another embodiment, the heating element of the second cooking portion includes an electrical heating element positioned adjacently below the fan.

In another embodiment, the first cooking portion includes a smoke shield positioned over the pellet cup. In still another embodiment, the first cooking portion and the second cooking portion of the main body are positioned to define a spaced gap therebetween. In another embodiment, the first cooking portion comprises a lid pivotably moveable between a closed position and an open position, wherein, upon the lid being in the closed position, the lid defines vent openings therein positioned along a rear side of the lid, the vent openings configured to vent smoke from the smoker chamber. In another embodiment, the second cooking portion includes a housing and chamber walls, the chamber walls configured to at least partially surround and define the air frying chamber, the housing extending to at least partially surround the chamber walls to define an air gap between the housing and the chamber walls. In still another embodiment, the first cooking portion of the main body extends to at least partially define a cylindrical structure, the cylindrical structure defining an axis that extends through a pivot point of a lid of the first cooking portion.

In another embodiment, the main body includes ducting and a motor fan, the ducting extending between the smoker chamber and the air fryer chamber such that the motor fan is configured to draw smoke from the smoker chamber to the air fryer chamber. In still another embodiment, the motor fan is activated with movement of a linkage from a first position to a second position, wherein, upon the linkage being moved to the second position, a portion of the linkage is removed from the ducting to facilitate air flow therethrough and a portion of the linkage triggers a connection piece of a switch to electrically activate the motor fan.

In accordance with another embodiment of the present invention, an outdoor cooking station configured to independently cook food with different cooking modes and with separate fuel sources, one of the cooking modes configured to burn pellet elements to produce heated smoke is provided. The outdoor cooking station includes a main body and a pellet feeder system. The main body extends to define a first cooking portion and a second cooking portion for cooking in the different cooking modes, the first cooking portion and the second cooking portion being separate so as to be configured to be dedicated to cooking food simultaneously and independent of each other with the different cooking modes. The first cooking portion includes a smoker chamber with a grill cooking surface suspended therein, and includes an electrical pellet burner element positioned below the smoker chamber and configured to supply heated smoke to the smoker chamber. The second cooking portion of the main body extends to define an air frying chamber, the air frying chamber being accessible with a removable insert having a wall and a basket. The basket is coupled to one side of the wall and a grip is positioned on another side of the wall. The wall of the insert is positioned within an opening of the air frying chamber such that the basket is sized to be positioned within the air frying chamber. The second cooking portion includes a heating element and a fan positioned adjacent the heating element, the fan configured to move air over the heating element to mix air within the air frying chamber to facilitate cooking food placed within the basket of the insert. The pellet feeder system is coupled to the first cooking portion of the main body, the pellet feeder system including a hopper and a feeder, the hopper defining a hopper opening adjacent a lower end of the hopper and the hopper configured to hold the pellet elements. The feeder is positioned adjacent the hopper opening defined in the hopper such that the feeder is configured to rotate so as to deliver the pellet elements from the hopper opening defined in the hopper to a pellet cup within the first cooking portion so that the pellet elements are positioned adjacent the electrical pellet burner element of the first cooking portion of the main body.

In another embodiment, the first cooking portion includes a smoke shield positioned over the pellet cup. In another embodiment, the first cooking portion and the second cooking portion of the main body are positioned to define a spaced gap therebetween. In still another embodiment, the second cooking portion includes a housing and chamber walls, the chamber walls configured to at least partially surround the air frying chamber, the housing extending to at least partially surround the chamber walls to define an air gap between the housing and the chamber walls.

In another embodiment, the first cooking portion includes a lid pivotably moveable between a closed position and an open position, wherein, upon the lid being in the closed position, the lid defines vent openings therein positioned along a rear side of the lid, the vent openings configured to vent smoke from the smoker chamber. In another embodiment, the first cooking portion of the main body extends to at least partially define a cylindrical structure, the cylindrical structure defining an axis that extends through a pivot point of the lid.

In another embodiment, the main body comprises ducting and a motor fan, the ducting extending between the smoker chamber and the air fryer chamber such that the motor fan is configured to draw smoke from the smoker chamber to the air fryer chamber. In another embodiment, the motor fan is activated with movement of a linkage from a first position to a second position, wherein, upon the linkage being moved to the second position, a portion of the linkage is removed from the ducting to facilitate air flow therethrough and a portion of the linkage triggers a connection piece of a switch to electrically activate the motor fan.

In accordance with another embodiment of the present invention, a method for cooking food in the outdoors is provided. The method includes the steps of: providing an outdoor cooking station with a main body extending to define a first cooking portion and a second cooking portion, the first cooking portion and the second cooking portion being separate so as to be dedicated to cooking food simultaneously and independent of each other with different cooking modes, the first cooking portion including a smoker chamber and the second cooking portion including an air frying chamber, the second cooking portion including a heating element and a fan for heating the air frying chamber, the main body including a pellet feeder system coupled thereto for heating the smoker chamber with pellet elements, the pellet feeder system including a hopper and a feeder, the hopper sized and configured to hold pellet elements therein and to be moved therefrom by the feeder; opening a door to the smoker chamber of the first cooking portion to position food on a grill cooking surface suspended within the smoker chamber and then closing the door to enclose the food within the smoker chamber; positioning other food in a basket of a removable insert to then position the basket within the air frying chamber; feeding the pellet elements from a hopper opening defined in a lower end of the hopper with rotation of the feeder to deliver the pellet elements to a pellet cup positioned in the first cooking portion and adjacent a pellet burner element; heating the smoker chamber by burning the pellet elements with a pellet burner element to generate smoke so that heated smoke moves into the smoker chamber to heat the food on the grill cooking surface; and heating the air frying chamber with the heating element and the fan such that the fan moves air over the heating element and mixes the heated air in the air frying chamber for cooking the other food in the basket.

In another embodiment, the method step of providing includes providing ducting and a motor fan, the ducting extending between the smoker chamber and the air fryer chamber such that the motor fan is configured to draw smoke from the smoker chamber to the air fryer chamber. In another embodiment, the method further includes activating the motor fan by moving a linkage from a first position to a second position so that a portion of the linkage is removed from the ducting to facilitate air flow through the ducting. In another embodiment, the activating the motor fan includes triggering a connection piece of a switch with the linkage so that the connection piece of the switch electrically engages a conductor of the switch to electrically activate the motor fan.

In accordance with another embodiment of the present invention, an outdoor cooking station configured to independently cook food with different cooking modes and with separate fuel sources, one of the cooking modes configured to burn pellet elements to produce heated smoke is provided. The cooking station includes a main body and a pellet feeder system. The main body extends to define a first cooking portion and a second cooking portion for cooking in the different cooking modes, the first cooking portion and the second cooking portion being separate so as to be configured to be dedicated to cooking food simultaneously and independent of each other with the different cooking modes. The first cooking portion includes a smoker chamber with a grill cooking surface suspended therein, and including a pellet burner element positioned below the smoker chamber and configured to supply heated smoke to the smoker chamber. The second cooking portion of the main body extends to define a secondary cooking chamber, the secondary cooking chamber including a heating element positioned therein for heating the secondary cooking chamber. Further, the main body includes ducting extending between the smoker chamber and the secondary cooking chamber with a motor fan positioned adjacent to the ducting. The pellet feeder system is coupled to the first cooking portion of the main body, the pellet feeder system includes a hopper and a feeder, the hopper defining an opening adjacent a lower end of the hopper and the hopper configured to hold the pellet elements. The feeder is positioned adjacent the opening defined in the hopper such that the feeder is configured to rotate so as to deliver the pellet elements from the opening defined in the hopper to a pellet cup so that the pellet elements are positioned adjacent the pellet burner element of the first cooking portion of the main body. With this arrangement, upon the pellets being ignited to generate smoke within the smoker chamber and upon the motor fan being activated, the motor fan is configured to draw smoke from the smoker chamber to move through the ducting and into the secondary cooking chamber.

In another embodiment, the motor fan is activated with movement of a linkage from a first position to a second position, wherein, upon the linkage being moved to the second position, a portion of the linkage is removed from the ducting to facilitate air flow therethrough and a portion of the linkage triggers a connection piece of a switch to electrically activate the motor fan. In another embodiment, the secondary cooking chamber includes a fan positioned adjacent the heating element, the fan configured to move air over the heating element and to mix air within the secondary cooking chamber to facilitate cooking food within the secondary cooking chamber.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a perspective view of a cooking station having both a griddle cooking portion and a smoker cooking portion, according to an embodiment of the present invention;

FIG. 2 is a partially exploded perspective view of the cooking station of FIG. 1, depicting heating elements for the griddle cooking portion and a door of a smoker chamber in an open position, according to another embodiment of the present invention;

FIG. 3 is a cross-sectional perspective view of the cooking station taken along section line A-A of FIG. 1, according to another embodiment of the present invention;

FIG. 4 is a front cross-sectional view of the cooking station taken along section line A-A of FIG. 1, according to another embodiment of the present invention;

FIG. 5 is an enlarged front cross-sectional view of a pellet feeder system, according to another embodiment of the present invention;

FIG. 6 is a schematic view of a control system associated with the cooking station of FIG. 1, according to another embodiment of the present invention;

FIG. 7 is a perspective front view of another embodiment of an outdoor cooking station, depicting a first cooking portion and a second cooking portion in a side-by-side arrangement, according to the present invention;

FIG. 8 is a partial cross-sectional view of the first and second cooking portions of the cooking station taken along section line B-B of FIG. 7, according to another embodiment of the present invention;

FIG. 9 is a perspective view of another embodiment of a cooking station, depicting the cooking station having a griddle portion and an oven portion positioned in a side-by-side manner, according to the present invention;

FIG. 10 is a perspective view of the cooking station of FIG. 9, depicting a hood of the griddle portion in an open position, according to another embodiment of the present invention;

FIG. 11 is a front view of the cooking station, according to another embodiment of the present invention;

FIG. 12 is a side view of the cooking station, according to another embodiment of the present invention;

FIG. 13 is a perspective cross-sectional view of the cooking station taken along section line 13-13 of FIG. 12, according to another embodiment of the present invention;

FIG. 14 is a perspective cross-sectional view of the cooking station taken along section line 14-14 of FIG. 12, according to another embodiment of the present invention;

FIG. 15 is a cross-sectional view of the cooking station taken along section line 15-15 of FIG. 11, according to another embodiment of the present invention;

FIG. 16 is a cross-sectional view of the cooking station taken along section line 16-16 of FIG. 12, according to another embodiment of the present invention;

FIG. 17 is a perspective view of a cooking station having both a smoker cooking portion and an air fryer cooking portion, according to an embodiment of the present invention;

FIG. 18 is a perspective view of the cooking station depicting the smoker cooking portion the air fryer cooking portion with a lid in an open position, according to another embodiment of the present invention;

FIG. 19 is a rear perspective view of the cooking station, according to another embodiment of the present invention;

FIG. 20 is a cross-sectional view of the cooking station taken along section line of 20-20 of FIG. 23, according to another embodiment of the present invention;

FIG. 21 is a cross-sectional view of the air fryer cooking portion taken along section line 21-21 of FIG. 17, depicting portions of the air fryer cooking portion (but with an insert removed from a baking chamber of the air fryer cooking portion), according to another embodiment of the present invention;

FIG. 21A is an enlarged view taken from region 21A of FIG. 21, depicting a baking chamber of the air fryer cooking portion, according to another embodiment of the present invention;

FIG. 22 is a cross-sectional view of the cooking station taken along section line 22-22 of FIG. 23, according to another embodiment of the present invention;

FIG. 22A is an enlarged view taken from area 22A of FIG. 22, depicting the baking chamber of the air fryer cooking portion, according to another embodiment of the present invention;

FIG. 23 is a side view of the cooking station, according to another embodiment of the present invention;

FIG. 24 is a perspective view of the cooking station with portions of a smoker chamber removed, according to another embodiment of the present invention;

FIG. 24A is an enlarged view of the cooking station taken from region 24A of FIG. 24, depicting a ducting inlet of ducting extending from the smoker chamber, according to another embodiment of the present invention;

FIG. 25 is a rear perspective view of the cooking station with a rear panel removed from the air fryer device, according to another embodiment of the present invention;

FIG. 25A is an enlarged view of the cooking station taken from region 25A of FIG. 25, depicting the ducting extending from the smoker chamber toward the air fryer chamber, according to another embodiment of the present invention;

FIG. 26 is another rear perspective view of the cooking station with the rear panel removed from the air fryer device, according to another embodiment of the present invention;

FIG. 26A is an enlarged view of the cooking station taken from region 26A of FIG. 26, depicting the ducting and a motor fan positioned adjacent the ducting and a ducting outlet, according to another embodiment of the present invention;

FIG. 27 is a front view of the cooking station with the insert removed from the cooking station, depicting the ducting outlet at the air fryer chamber, according to another embodiment of the present invention;

FIG. 28A is a schematic side view of a blocking linkage and switch in a first position, according to another embodiment of the present invention;

FIG. 28B is a schematic top view of the blocking linkage and switch in the first position, according to another embodiment of the present invention;

FIG. 29A is a schematic side view of the blocking linkage and switch in a second position, according to another embodiment of the present invention;

FIG. 29B is a schematic top view of the blocking linkage and switch in the second position, according to another embodiment of the present invention; and

FIG. 30 is a schematic of a switch and motor fan of the cooking station, according to another embodiment of the invention.

### DETAILED DESCRIPTION OF THE INVENTION

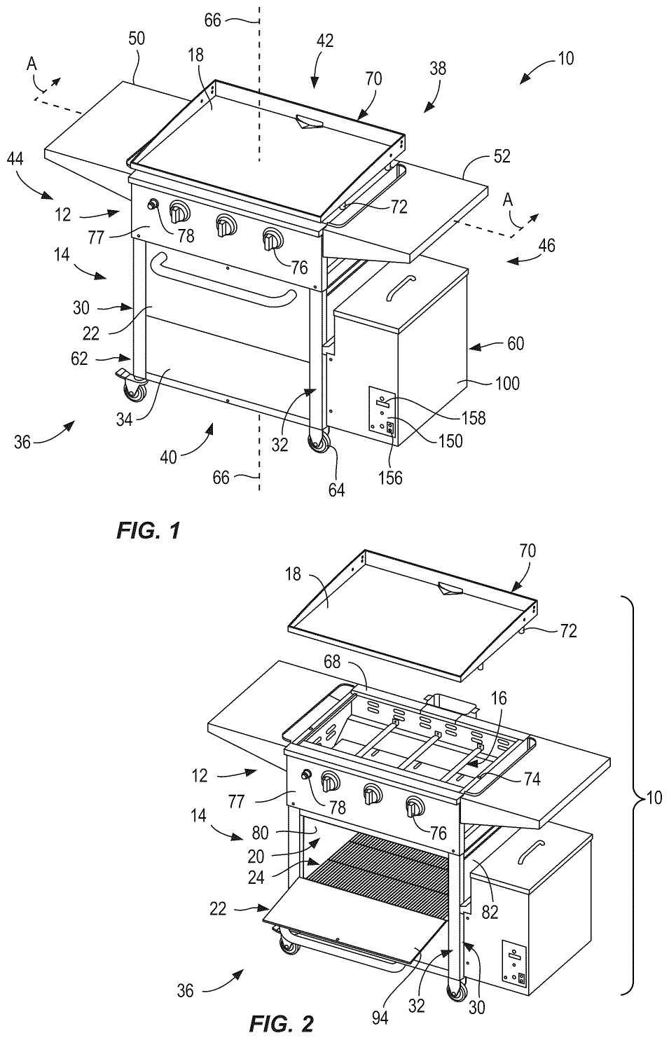

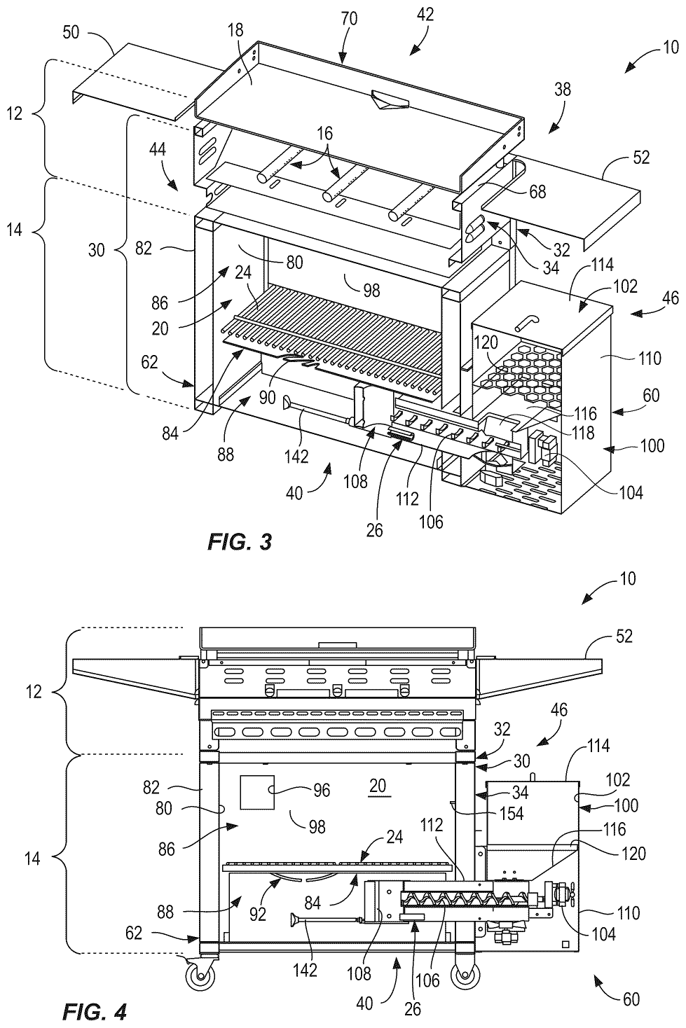

Referring to FIGS. 1 and 2, one embodiment of a cooking station 10 sized and configured to cook food with separate and independent cooking modalities or modes is provided. The cooking station 10 may be an outdoor type cooking station. Further, the cooking station 10 may include structural characteristics that facilitate portability of the cooking station 10. The cooking station 10 may include an upper cooking portion 12 and a lower cooking portion 14 such that each cooking portion is separate and independent from the other and may be employed to cook food simultaneously with the cooking station 10. The upper cooking portion 12 may include a first heating element 16 that may be gas fueled and sized and configured to heat a first cooking surface 18, such as a grill structure or griddle member. The lower cooking portion 14 may be in the form of a smoker chamber 20 accessible with a door 22, the smoker chamber 20 including a second cooking surface 24 suspended above a second heating element 26 (FIG. 3). The second heating element 26 may be sized and configured to electrically heat pellet elements (not shown) to supply heated smoke to the second cooking surface 24 within the chamber 20. In this manner, the cooking station 10 may be employed to cook food simultaneously in different cooking modes and with independent, separate, and different heat sources, each cooking mode providing a unique flavor and texture to the food being cooked. As such, the cooking station 10 provides a compact and portable outdoor cooking station that facilitates cooking food in at least two different cooking modes that traditionally would require at least two separate stand-alone cooking stations.

With reference to FIGS. 1-3, the cooking station 10 may include a main body 30 extending to define and support the upper and lower cooking portions 12, 14. The main body 30 may include frame components 32 with various panels 34 secured to the frame components 32 to define the upper and lower cooking portions 12, 14. For example, the frame components 32 may extend with vertically extending frame components and horizontally extending frame components with the panels 34 attached thereto to define a front side 36, a rear side 38, a bottom side 40, a top side 42, a first side 44 and a second side 46 of the main body 30. The front side 36 may generally face opposite relative to the rear side 38 of the main body 30. Likewise, the bottom side 40 may generally face opposite relative to the top side 42 or upper side, and the first side 44 may face generally opposite from the second side 46 of the main body 30. In this manner, the main body 30 may externally extend to define a generally box-shaped cubical structure. Further, the cooking station 10 may include a first side shelf 50 and a second side shelf 52 attached to first and second sides 44, 46 of the main body 30 such that the first and second side shelves 50, 52 may be generally level with the top side 42 of the main body 30. In another embodiment, the first and second side shelves 50, 52 may be off-set to a lower position relative to the top side 42 of the main body 30. Also, the second side 46 (or the first side 44) of the main body 30 may include a pellet feeder system 60 coupled to a lower portion 62 of the main body 30, discussed in more detail herein, such that a portion of the pellet feeder system 60 may be positioned below the second side shelf 52. Further, at the lower portion 62 of the main body 30, the main body 30 may include caster wheels 64 or the like to be coupled at an end of legs or the vertically extending frame components so as to facilitate portability of the cooking station 10. In one embodiment, the main body 30 may include four caster wheels 64. In another embodiment, the main body 30 may include two caster wheels 64. In another embodiment, the caster wheels 64 may be coupled directly to vertically extending frame components. In another embodiment, the caster wheels 64 may be coupled to horizontally extending frame components adjacent to the bottom side 40 of the main body 30.

Within the main body 30, the upper cooking portion 12 may be positioned directly above the lower cooking portion 14 such that a vertically extending central axis 66 of the main body 30 may extend centrally through the upper and lower cooking portions 12, 14 and, further, such that the central axis 66 extends centrally through the first and second cooking surfaces 16, 24. In regard to the upper cooking portion 12, the frame components 32 with the panels 34 attached thereto may define an open-ended box-like structure extending upward from the lower cooking portion 14 to an upper edge 68. The panels 34 of the upper cooking portion 12, along the rear side 38, the first side 44, and second side 46 may include venting structure defined therein.

The upper edge 68 may extend horizontally to define a rectangular periphery that may define the top side 42 of the main body 30. Such upper edge 68 may extend adjacent to the first cooking surface 18. In one embodiment, the first cooking surface 18 may be a flat surface and may extend to define a griddle member 70 such that the upper edge 68 may be sized and configured to support the griddle member 70. For example, the griddle member 70 may include griddle legs 72 that extend from a bottom surface of the griddle member 70 such that the griddle legs 72 may be sized to sit within apertures 74 defined on the first and second sides 44, 46 of the upper edge 68 of the main body 30. In another embodiment, the upper edge 68 of the main body 30 may extend adjacent to a grill member (not shown) extending between opposite sides of the upper edge 68, such as between first and second sides 44, 46 and front and rear sides 36, 38 of the upper edge 68. In still another embodiment, the upper edge 68 of the upper cooking portion 12 of the main body 30 may be sized and configured to support a pivoting hood (not shown) or the like associated with the main body 30, the hood being pivotably coupled to the rear side 38 of an upper cooking portion 12 of the main body 30, such as adjacent the rear side 38 of the upper edge 38.

Further, the front side 36 of the upper cooking portion 12 may include multiple burner control valves 76 or knobs positioned over a front panel 77. Each of the burner control valves 76 or knobs may be associated with one of the first heating elements 16 or flame burners. The first heating elements 16 may extend between the front side 36 and rear side 38 of the main body 30 below the upper edge 68 of the main body 30 such that the first heating elements 16 may be secured to the frame components 32 extending within and adjacently along the front and rear sides 36, 38 of the main body 30. Each of the first heating elements 16 may hold structure for feeding pressurized fuel therethrough, such as propane gas or natural gas, and controlled with the burner control valves 76 or knobs. In addition, the front panel 77 may include an ignitor switch 78 that may be depressed to provide a spark to ignite the gas fueled first heating elements 16. The cooking station 10 may include various typical components to facilitate igniting the first heating elements 16 and heating the first cooking surface 18 associated with the cooking station 10, such as various valves, tubing, manifold, gas couplings, fasteners, and any other components, as known to one of ordinary skill in the art. Further, the cooking station 10 may include a propane tank holder (not shown) attached to the lower portion 62 of the main body 30, such as adjacent the first side 44, second side 46, or rear side 38 of the main body 30. The propane tank holder may support a propane tank (not shown) thereon which may be coupled to the cooking station 10 via the typical components for feeding propone to the first heating elements 16, as known by one of ordinary skill in the art. With this arrangement, the cooking station 10 may be employed for heating the first cooking surface 18 for cooking food with the upper cooking portion 12 of the cooking station 10.

Now with reference to FIGS. 2, 3 and 4, the lower cooking portion 14 of the main body 30 of the cooking station 10 may extend with the frame components 32 and panels 34 attached thereto so as to generally define a cubical shaped chamber, such as the before discussed smoker chamber 20. For example, some of the frame components 32 may extend vertically downward directly from the upper cooking portion 12 and some of the frame components 32 may extend horizontally below the upper cooking portion 12 and along a bottom of the lower cooking portion 14 (or bottom side 40 of the main body 30) so that the panels 34 may be coupled thereto to define walls of the lower cooking portion 14. The walls of the lower cooking portion 14 may define inner and outer panels 80, 82 extending to define the lower cooking portion 14. In one embodiment, the inner and outer panels 80, 82 may extend to define a space therebetween that may include insulation material or the like within the space between the inner and outer panels 80, 82.

The lower cooking portion 14 and the smoker chamber 20 may be separated by a horizontally suspended panel or smoke shield 84 to define an upper smoker portion 86 (or upper region) and a lower smoker portion 88 (or lower region) of the smoker chamber 20. Such smoke shield 84 may sit over brackets or the like for suspending the smoke shield 84 horizontally along a mid-portion of the smoke chamber 20. Further, the smoke shield 84 may define an aperture 90 or smoke opening therein that may be off-set relative to the second heating element 26 positioned in the lower smoker portion 88, the aperture 90 including a screen or grate like structure so as to minimize ash from passing through the aperture 90, but also facilitate smoke for passing through the screen and aperture 90 defined in the smoke shield 84. The aperture 90 may be defined with bowed structure 92 extending slightly downward in a bowing manner from the remaining structure of the smoke shield 84. Further, the upper smoker portion 86 of the smoke chamber 20 may include a smoke outlet 96 defined in a vertically extending rear panel 98 of the lower cooking portion 14 such that the smoke outlet 96 may be positioned along the rear panel 98 within an upper portion of the upper smoker portion 86. In one embodiment, the smoke outlet 96 may include moveable structure to facilitate minimizing and enlarging the size of the smoke outlet 96, such as a slideable plate that may be pivotably moveable or linearly moveable over the smoke outlet 96.

The upper smoker portion 86 of the lower cooking portion 14 or smoke chamber 20 may include the second cooking surface 24 or grate like structure that may be suspended by brackets or a ledge within the upper smoker portion 86 and above the smoke shield 84. In another embodiment, the second cooking surface 24 may be in the form of hooks for suspending food in the smoke chamber 20 and may be included additionally to the grate like structure. Such second cooking surface 24 and upper smoker portion 86 may be accessible from the front side 36 of the lower cooking portion 14 with the door 22. Such door 22 may be pivotably coupled to the front side 36 of the main body 30 along a bottom end of the door 22 with, for example, hinge components positioned adjacent bottom corners of the door 22. In this manner, the door 22 may be pivotably coupled so as to be movable between an open position and a closed position. With the door 22 in the open position, the upper smoke portion may be accessible for placing and removing food positioned on the second cooking surface 24. Further, in the open position, the second cooking surface 24 and the smoke shield 84 may be removed from the upper smoker portion 86 for cleaning purposes and for accessing the lower smoker portion 88.

With the door 22 in the closed position, the lower cooking portion 14 and the smoke chamber 20 may be sized and configured to hold heated smoke therein so as to slowly cook food positioned on the second cooking surface 24 or grate. In one embodiment, the door 22 may be spring biased to the closed position. The door 22, such as along an inner peripheral surface 94 of the door 22, may sit against the main body 30 such that a resilient material (not shown) disposed between the inner peripheral surface 94 and the main body 30 may substantially seal the door 22 in the closed position. In this manner, heated smoke may be maintained in the smoke chamber 20 so that smoke leaking from the smoke chamber 20 is minimal except though the smoke outlet 96 defined in the main body 30, such as in the rear panel 98 of the lower cooking portion 14. The user may control the amount of smoke escaping through the smoke outlet 96 by modifying the size of the smoke outlet 96, as previously set forth.

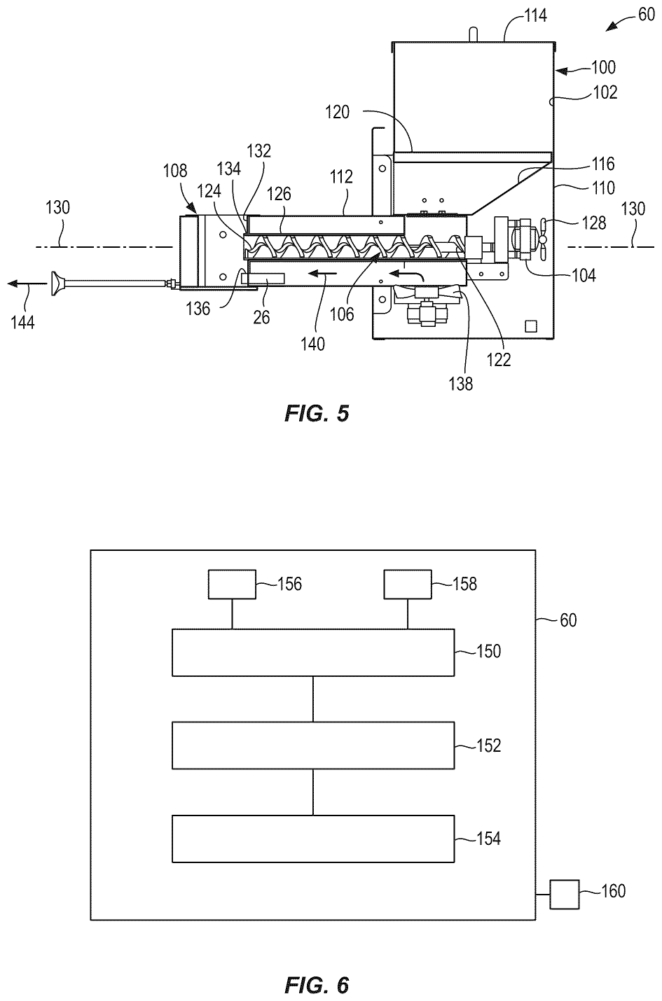

Now with reference to FIGS. 3, 4, and 5, as previously set forth, the pellet feeder system 60 may be attached to the lower portion 62 of the main body 30 along the second side 46 of the main body 30. In one embodiment, the pellet feeder system 60 may be at least partially positioned below the second side shelf 52 of the cooking station 10. The pellet feeder system 60 may be sized and configured to feed pellets to the second heating element 26 for generating heated smoke to the smoke chamber 20. Such pellet feeder system 60 may include a housing 100, a pellet hopper 102, a motor 104, an auger 106, and the second heating element 26, each of which cooperate together to feed pellets to a pellet cup 108 coupled to and/or supporting the second heating element 26. The housing 100 of the pellet feeder system 60 may define an upright extending portion 110 and a laterally extending portion 112, the upright extending portion 110 having a generally cubical external shape with the lateral portion 112 extending from the upright portion 110 and into the lower smoker portion 88. The upright extending portion 110 of the housing 100 may hold the pellet hopper 102, the motor 104 and a portion of the auger 106. The upright extending portion 110 of the housing 100 may include a lid 114 at a top end of the housing 100 that may be pivotably coupled to the top end so that the inside of the pellet hopper 102 may be accessed to pour pellets therein. The laterally extending portion 112 of the housing 100 may hold the remaining portion of the auger 106 and may extend laterally from a lower portion of the upright extending portion 110 of the housing 100.

The pellet hopper 102 may be defined at least partially by the housing 100 of the upright extending portion 110. For example, the pellet hopper 102 may be defined by a hopper floor 116 and an upper portion of the upright extending portion 110 of the housing 100. The pellet hopper 102 may be sized and configured to hold pellets (not shown) therein and to funnel the pellets to an auger entry portion 118. As such, the hopper floor 116 may be oriented at an angled position so that the pellets may funnel toward the auger entry portion 118 of the pellet hopper 102. Further, the pellet hopper 102 may include a screen 120 or grate structure therein to screen clumped pellets from moving to the auger entry portion 118 of the pellet hopper 102. The auger 106 may extend horizontally with a helical configuration between a first end 122 and a second end 124 such that the auger 106 extends through a tube 126. The first end 122 of the auger 106 may be coupled to the motor 104 to facilitate rotation of the auger 106, as known to one skilled in the art. The motor 104 may be an electrically driven motor with a first fan 128 positioned adjacent thereto to assist in cooling the motor 104. As the motor 104 rotates the auger 106 about an auger axis 130 thereof, the auger 106 may feed pellets through the tube 126 and into the pellet cup 108. In this manner, the end of the tube 126 and second end 124 of the auger 106 may be positioned adjacent an upright wall 132 of the pellet cup 108.

The pellet cup 108 may include the upright wall 132 with an upper hole 134 and a lower hole 136 each defined in the upright wall 132, the upper hole 134 positioned directly above the lower hole 136 of the pellet cup 108. The pellet cup 108 may support the tube 126 such that the end of the tube 126 and second end 124 of the auger 106 may be positioned slightly through the upper hole 134 of the pellet cup 108. The lower hole 136 of the pellet cup 108 may hold the second heating element 26 such that the second heating element 26 extends through the lower hole 136 and may be disposed below the end of the tube 126. The second heating element 26 may be electrically heated, as known to one of ordinary skill in the art, so as to burn the pellets feeding in the pellet cup 108 to generate heated smoke. The pellet feeder system 60 may also include a second fan 138. The second fan 138 may be employed to provide air flow, as shown by arrow 140, to the burning pellets so that the burning pellets may be fueled to burn hotter in the pellet cup 108. The second fan 138 may be positioned below the laterally extending portion 112 and within the upright extending portion 110 of the housing 100. The pellet cup 108 may include appropriate venting to facilitate the air flow to the pellets within the pellet cup 108. With this arrangement, the second heating element 26 may burn pellets being fed within the pellet cup 108 and air flow may fan the burning pellets to increase the heat produced by the burning pellets.

Further, the pellet cup 108 may be removed or partially removed from an end of the laterally extending portion 112 of the housing 100 so that ash built-up in the pellet cup 108 may be removed. For example, the pellet cup 108 may be removed by pulling on a slideable rod 142 extending from the pellet cup 108, as shown by arrow 144. Such rod 142 may also be rotatable and slidable in order to decouple the pellet cup 108 (or a portion thereof) from the housing 100. In this manner, as ash is formed from burning the pellets with the second heating element 26, a user may access the lower smoker portion 88 of the smoker chamber 20, de-couple the pellet cup 108 and discard the ash therein. The user may then re-attach the pellet cup 108 in its appropriate position in the smoker chamber 20.

In another embodiment, with reference to FIGS. 1, 4 and 6, the pellet feeder system 60 may include a control panel 150 positioned on, for example, the front side 36 of the housing 100 of the pellet feeder system 60. The control panel 150 may be coupled to a controller 152 and a temperature sensor 154. The control panel 150 may include input controls 156, such as input buttons, and an output 158, such as a display. Further, the pellet feeder system may be coupled to a power connection 160 for electrically powering the components coupled to the control panel 150 as well as the other components of the pellet feeder system 60, as known to one of ordinary skill in the art. The controller 152 may be sized and configured to control components of the pellet feeder system 60, such as the motor 104, the second heating element 26, and the first and second fans 128, 138. The temperature sensor 154 may be positioned within or adjacent the inner panel 80 of the upper smoker portion 86 and may be sized and configured to sense an actual temperature of the upper smoker portion 86, such that the actual temperature may be viewable on the display of the control panel 150. With this arrangement, a user of the lower cooking portion 14 of the cooking station 10 may employ the input controls 156 to input a period of time for cooking the food product in the smoker chamber 20 as well as input a desired temperature for maintaining the smoker chamber 20 of the cooking station 10 over the period of time. The controller 152 in cooperation with the temperature sensor 154 may control activation and deactivation of the motor 104 for supplying pellets via the auger 106 into the pellet cup 108 as well as activate and deactivate heating the second heating element 26 to burn the pellets to generate heated smoke. The controller 152 may also control running the second fan 138 to provide air flow to the pellet cup 108 with the burning pellets to assist in the pellets burning hotter to generate additional heated smoke. Further, the controller 152 may control the first fan 128 to assist in cooling the motor 104.

Upon the actual temperature of the smoker chamber 20 meeting the desired temperature previously set with the input controls 156, as sensed by the temperature sensor 154, the controller 152 may maintain the actual temperature to about the desired temperature in the smoker chamber 20 by activating the motor 104, the second fan 138, and/or the second heating element 26, as needed. In this manner, the actual temperature of the smoker chamber 20 may be maintained to approximately the desired temperature for the period of time set with the input controls 156 on the control panel 150. Further, in another embodiment, the input and output controls may be controlled and viewed remotely with application software via the Internet from a user's mobile phone. Such remote control may be advantageous due to the long period of time required to cook food through heated smoke in the smoker chamber 20.

At any time, such as while cooking food in the smoker chamber 20, a user may cook other food with the gas fueled first heating element 16 (FIG. 2) on the first cooking surface 18, such as on the griddle member 70 or on a grill structure, as previously set forth. As such, the cooking station 10 provides a single portable compact unit that may be employed to cook food in different cooking modes, one cooking mode being gas fueled and the other cooking mode being electrically activated to burn pellets for generating heated smoke. In this manner, a user of the cooking station 10 can slowly cook food in the smoker chamber 20 over a long period of time to obtain the desired smoked flavor in the food while also being able to employ another cooking mode with the cooking station 10, independent of the smoker chamber 20, to cook over gas fueled burners to heat the griddle member 70 of the cooking station 10.

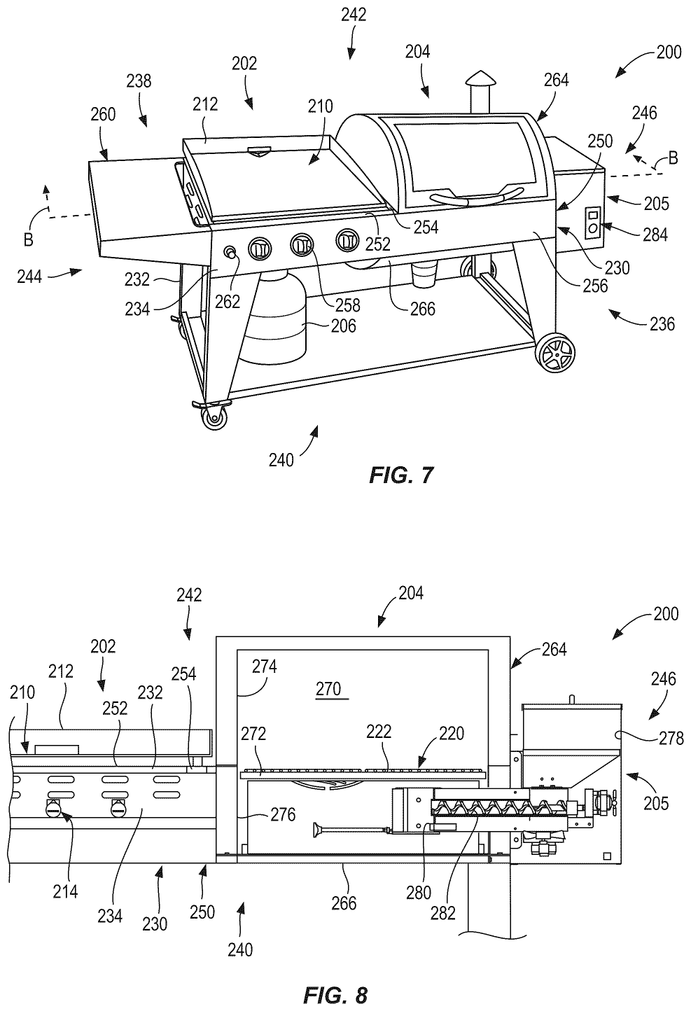

With reference to FIGS. 7 and 8, another embodiment of a cooking station 200 with duel cooking modes is provided. In this embodiment, the cooking station 200 may include similar functionality as the previous embodiment, except instead of the cooking station having the duel cooking modes in a stacked arrangement, the duel cooking modes may be in a side-by-side arrangement within a stand-alone portable cooking unit. For example, the cooking station 200 may include a first cooking portion 202 and a second cooking portion 204 each with separate first and second fuel sources. The first fuel source may be fueled with gas from, a propane tank 206, or natural gas fed via gas lines, for example. The second fuel source may be a pellet feeder system 205, electrically heating/burning pellets (not shown) to create heated smoke. As such, the first cooking portion 202 may include a first cooking surface 210, such as a griddle member 212, which may be heated via first heating elements 214 fueled by the first fuel source, similar to that described and depicted for the upper cooking portion 12 of the cooking station 10 of FIGS. 1 and 2. The second cooking portion 204 may include a second cooking surface 220, such as a grill 222 or hooks, similar to the second cooking surface 24 described and depicted in FIG. 2. Further, the pellet feeder system 205 cooperating with the second cooking portion 204 of this embodiment may include the same components of the pellet feeder system 60 described and depicted relative to FIGS. 3-6.

The cooking station 200 of this embodiment may include a main body 230 extending with frame components 232 and panels 234 to define a front side 236, a rear side 238, a bottom side 240, a top side 242, a first side 244 and a second side 246. The front side 236 may be oppositely positioned relative to the rear side 236. The bottom side 240 may be opposite the top side 242. Similarly, the first side 244 may be opposite relative to the second side 246. The main body 230 of the cooking station 200 may include an upper portion 250, the upper portion 250 including the first and second cooking portions 202, 204 therein. The upper portion 250 defining an upper edge 252 extending along each of the above described front and rear sides 236, 238 and first and second sides 244, 246 to define a rectangular periphery of the main body 230 along the upper edge 252. The upper edge 252 may also define a cross-member 254 that may extend between the front side 236 and the rear side 238 of the upper edge 252, the cross-member 254 defining a separation between the first and second cooking portions 202, 204 of the main body 230. The cross-member 254 may extend between the front and rear sides 236, 238 of the upper edge 252 at about a mid-point therealong so that the first and second cooking portions 202, 204 may exhibit substantially equal cooking spaces or regions of the cooking station 200. The griddle member 212 may be positioned along the upper edge 252 adjacent the first side 244 and partial substantially equal portions of the upper edge 252 along the front and rear sides 236, 238 as well as on the cross-member 254. Further, the first cooking portion 202 may include burner valves 258 or knobs along a front panel 256 positioned along the front side 236 of the upper portion 250 of the main body 230. Each burner valve 258 may be associated with one of the first heating elements 214, similar to the first heating elements 16 of FIG. 2. The front panel 256 may also include an igniter switch 262 for igniting the first heating elements 214 for heating the griddle member 212. Further, the main body 230 may include a single side shelf 260 positioned adjacent the griddle member 212 along the first side 236 of the main body 230. Such side shelf 260 may include various features, such as an elongated opening and ridge arrangement, to discourage users from placing various cooking items or tools too close to the griddle member 212, similar to that disclosed in commonly owned U.S. Pat. No. 10,779,682, filed Mar. 25, 2019, entitled “OUTDOOR COOKING STATION, SIDE SHELF, AND METHOD THEREOF,” the disclosure of which is incorporated herein by reference in its entirety.

As previously set forth, the upper portion 250 of the main body 230 may also support the second cooking portion 204 of the cooking station 200. The second cooking portion 204 may include a pivoting lid 264 that may pivot about a hinge (not shown) along the rear side of the main body 230. Further, the second cooking portion 204 may define an underside panel 266 that may extend below or lower than the front panel 256 or be substantially level with a lower edge of the front panel 256, which may extend along an underside of the upper portion 250 between the cross-member 254 and the second side 246 of the main body 230 and the front and rear sides 236, 238 of the main body 230. In one embodiment, the underside panel 266 of the second cooking portion 204 may be in the form of a barrel belly type structure. The underside panel 266 and the pivoting lid 264 of the second cooking portion 204 may define a smoker chamber 270 that may be accessible by moving the pivoting lid 264 to an open position.

The smoker chamber 270 may include a smoke shield 272 therein, positioned horizontally on brackets, for example, so as to divide the smoker chamber 270 between an upper smoker region 274 and a lower smoker region 276, similar to the previous embodiment. Further, the upper smoker region 274 may include the grill 222 or grate like structure positioned just above the smoke shield 272, the grill 222 extending to define the second cooking surface 220 of the cooking station 200. The upper smoker region 274 may additionally include hooks for hanging food to be cooked within the upper smoker region 274. In one embodiment, the grill 222 or second cooking surface 220 may be positioned horizontally to be substantially level with the first cooking surface 210, such as the griddle member 212. In another embodiment, the grill 222 or second cooking surface 220 may be positioned lower within the smoker chamber 270 such that the grill 222 may be positioned at a level that is lower than the first cooking surface 210. As in the previous embodiment, the second cooking portion 204 may be heated with the pellet feeder system 205, which may include similar structural components as the pellet feeder system 60 cooperating with the lower cooking portion 14 described and depicted relative to FIGS. 4-6. For example, the pellet feeder system 205 may include a pellet hopper 278 for feeding pellets to a second heating element 280 with a motorized auger 280 and controlled from a control panel 284. As such, the pellet feeder system 205 of this embodiment may function in the same manner and include the same structural components as described in the previous embodiment relative to FIGS. 4-6. In this manner, similar to the previous embodiment, the cooking station 200 may operate with separate cooking modes and from separate fuel sources for heating the first and second cooking portions 202, 204 independently and simultaneously all within a stand-alone portable cooking station 200 designed for the outdoors.

The various structural components of the various embodiments of the main body of the cooking station and the pellet feeder system and any other structural components thereof may be formed of various metallic materials, such as steel, stainless steel, copper, aluminum or any other suitable material with high temperature ratings, such as various suitable polymeric materials, and may be formed from known structural components, such as sheet metal at various gauges/thicknesses or other known metallic structures, such as tubing or the like, and may be formed and manufactured through various known processes and techniques known in the art, such as casting, welding, rolling, bending, pressing, fastening, etc., as known by one of ordinary skill in the art.

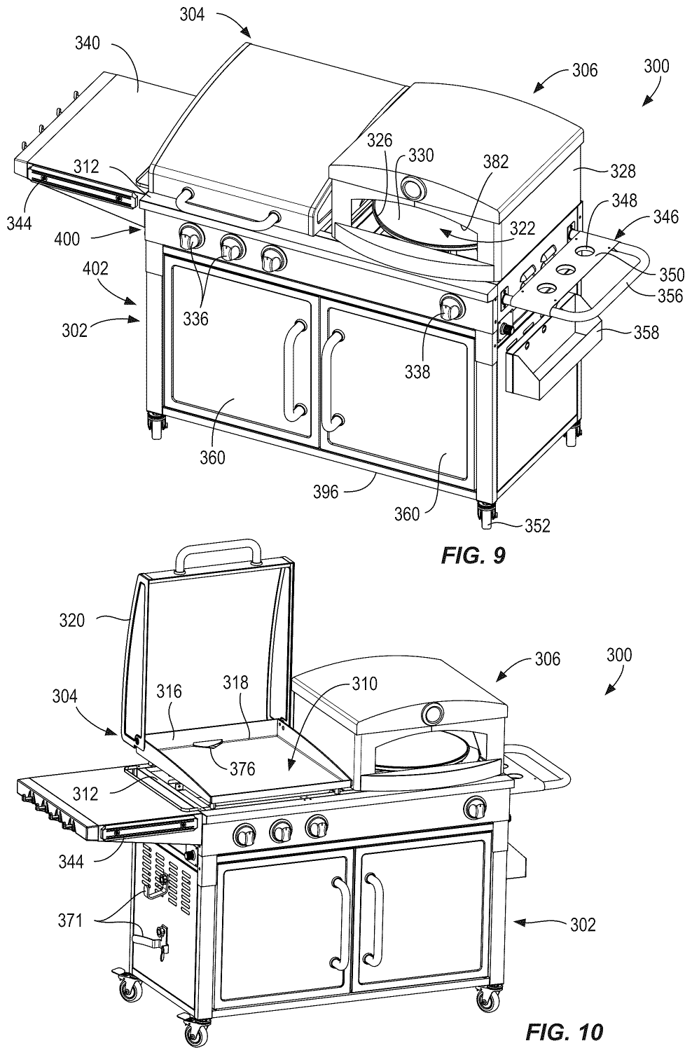

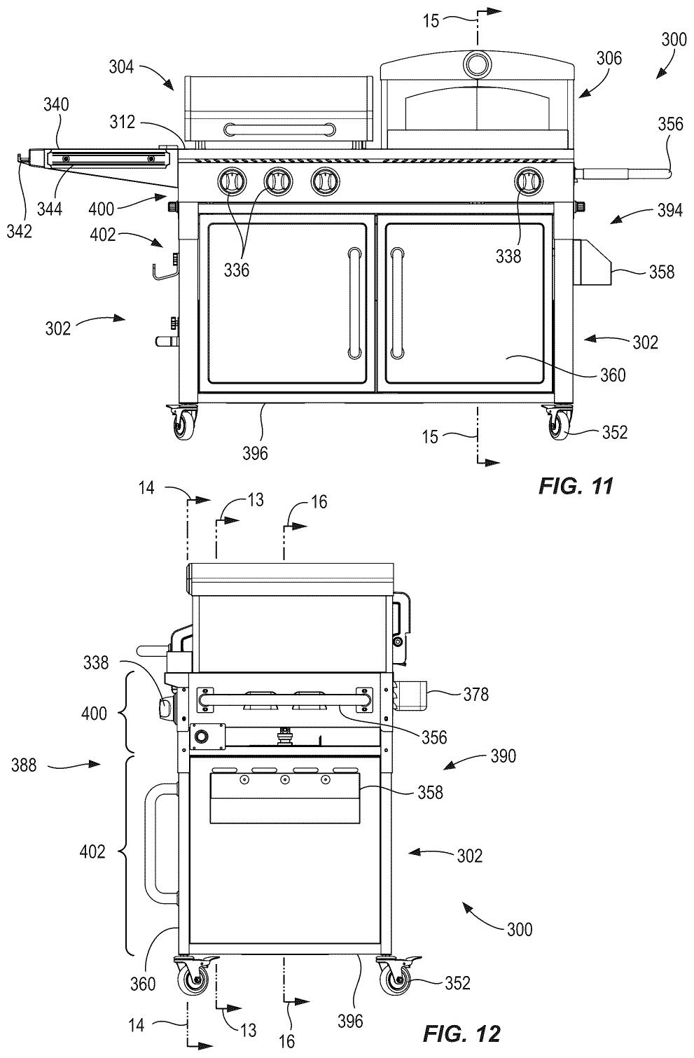

Now with respect to FIGS. 9, 10, 11, 12, and 13, in another embodiment, a cooking station 300 sized and configured to cook food in multiple separate and distinct cooking modes is provided. For example, the cooking station 300 may extend with a main body 302 with a griddle portion 304 and an oven portion 306 as the multiple separate and distinct cooking modes or multiple separate and distinct fuel sources. In this embodiment, the griddle portion 304 and the oven portion 306 may be positioned along the main body 302 in a side-by-side manner. Further, in this embodiment, the griddle portion 304 and the oven portion 306 may cook food separately and simultaneously, at different locations on the cooking station 300 and may be heated from distinct and dedicated fuel sources. In one embodiment, the griddle portion 304 and the oven portion 306 may be gas fueled with propane or natural gas and may include their own dedicated gas burners for the respective griddle portion 304 and the oven portion 306. Such gas burners may include one or more first gas burners 362 and one or more second gas burners 364, the one or more first gas burners 362 configured to fuel the griddle portion 304 and the one or more second gas burners 364 configured to fuel the oven portion 306. Further, the one or more first and second gas burners 362, 364 may be associated with their own dedicated first and second propane tanks (not shown), respectively. In addition, the main body 302 of the cooking station 300 may include a bottom panel 366, the bottom panel 366 defining a first opening 368 and a second opening 370 therein which may also be referenced as respective first and second fuel holding positions. The first and second openings 368, 370 defined in the bottom panel 366 may be sized and configured to hold, or nest with, first and second propane tanks (not shown), respectively, the first and second propane tanks positioned and configured to feed gas to the respective one or more first and second gas burners 362, 364. Further, in another embodiment, a propane tank holding structure 371 as one of the first and second fuel holding positions may be located along one side of the main body 302 of the cooking station 300, as depicted in FIG. 10.

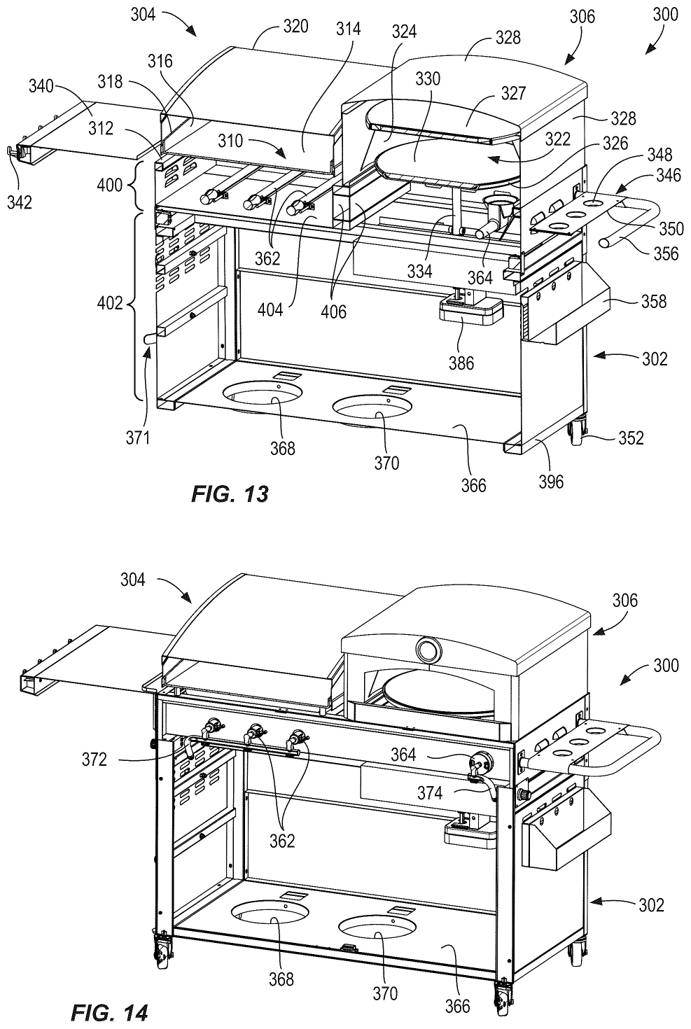

In another embodiment, as depicted in FIGS. 13 and 14, the one or more first and second gas burners 362, 364 may each be coupled to a first fuel tube 372 and a second fuel tube 374, respectively. The first fuel tube 372 may be sized and configured to be interconnected with a first propane tank (not shown) positioned at one of the first opening 368 defined in the bottom panel 366 or the propane tank holding structure 371 alongside the main body 302 of the cooking station 300. Similarly, the second fuel tube 374 may be sized and configured to be interconnected with a second propane tank (not shown) positioned at one of the first and second openings 368, 370 defined in the bottom panel 366 of the main body 302 of the cooking station 300. As such, the first and second fuel tubes 372, 374 may be separate from each other so as to feed gas from separate dedicated fuel sources to the one or more first and second gas burners 362, 364. Further, the one or more first and second gas burners 362, 364 of the cooking station 300 may include various typical components to facilitate igniting and feeding gas to the one or more first and second gas burners 362, 364 for heating the griddle portion 304 and the oven portion 306, respectively, such as various valves, tubing, manifold, gas couplings, fasteners, and any other components, as known to one of ordinary skill in the art.

With reference to FIGS. 10, 13, and 16, the griddle portion 304 may be similar to that depicted in the previous embodiments set forth herein. The griddle portion 304 may include a griddle member 310 positioned over an upper surface 312 of the main body 302 such that the griddle member 310 may be suspended over the one or more first gas burners 362. The griddle member 310 may include a flat griddle cooking surface 314 surrounded by a splash guard 316. The splash guard 316 may extend upward from the flat griddle cooking surface 314 along a periphery 318 of the cooking surface 314. Further the griddle member 310 may include a griddle hood 320 that may be pivotably coupled to, for example, the splash guard 316. In another embodiment, the griddle hood 320 may be pivotably coupled to a main body 302. The griddle hood 320 may be moved between an open position (FIG. 10) and a closed position (FIG. 9). In the closed position, such griddle hood 320 may be useful to protect the griddle member 310 from the outside elements when the griddle member 310 is not being used. Further, the hood 320 may typically be moved to the open position while cooking food on the griddle member 310 and, upon the food being cooked, gas flame burners may be turned off or down so that the hood may be moved to the closed position to keep the food warm on the flat griddle cooking surface 314 of the griddle member 310. In another embodiment, the griddle member 310 may include a griddle opening 376 defined therein. Such griddle opening 376 may be sized and configured to assist in managing grease or food byproduct from cooking on the griddle member 310 such that a grease cup 378 (FIG. 12) may be positioned below and/or rearward of the griddle opening 376 to collect the grease and food byproduct. The griddle portion 304 of the cooking station 300 may include structure and features, such as the griddle opening 376, similar to that disclosed in commonly owned U.S. Pat. No. 10,327,589, filed Dec. 21, 2018, entitled “OUTDOOR COOKING STATION WITH GRIDDLE, SYSTEM AND METHOD THEREOF,” the disclosure of which is incorporated by reference herein in its entirety.

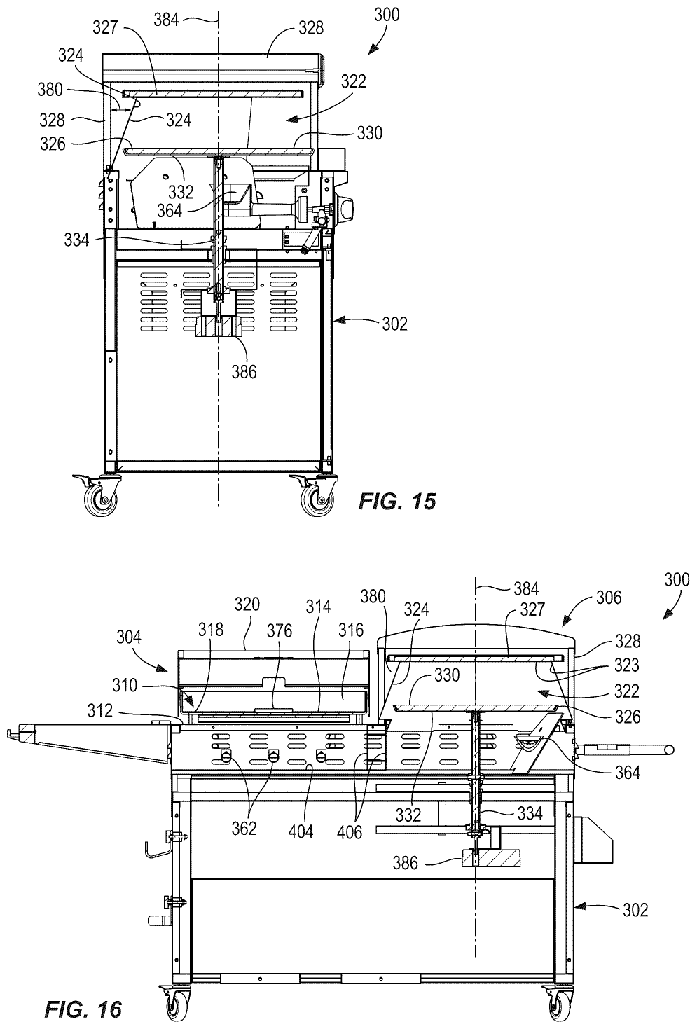

Now with reference to FIGS. 9, 13, 15, and 16, the oven portion 306 may be positioned adjacently to the side of the griddle portion 304 in the before-discussed side-by-side manner. The oven portion 306 may be sized and configured to cook pizza or the like within a cooking chamber 322 of the oven portion 306. The chamber 322 may be defined by an internal wall structure 323 and a lower stone 326. In another embodiment, the cooking chamber 322 may be defined by an internal wall 324, an upper stone 327, and the lower stone 326. In one embodiment, the internal wall structure 323 may extend with the internal wall 324 and the upper stone 327 such that the upper stone may be positioned on a ledge defined by the internal wall 324. In another embodiment, the internal wall structure 323 may act as a heat shield relative to an outer wall 328. Likewise, the internal wall 324 may act as a heat shield between the cooking chamber 322 and the outer wall 328. Such outer wall 328 may at least partially be an external shell or wall of the oven portion 306. Further, the oven portion 306 may define an air gap 380 between the internal wall 324 and the outer wall 326 as well as between the upper stone 327 and the outer wall 328. Also, the cooking chamber 322 may be accessible through a front opening 382, the front opening 382 defined by the internal wall 324 and/or the outer wall 328. Further, the lower stone 326 may define a stone cooking surface 330 sized and configured to cook pizza thereon or other food product within the cooking chamber 322. Further, the upper stone 327 may extend directly above the lower stone 326 in a substantially parallel arrangement such that the upper stone 327 may be heated within the cooking chamber 322 and radiate heat toward the lower stone 326 to assist in the cooking of food. The lower stone 326 may be positioned on a support panel 332. The support panel 332 may include a rod 334 coupled to a central portion of an underside of the support panel 332. The rod 334 may define an axis 384 that extends through a center of the support panel 332 and the lower stone 326. Such rod 334 may be coupled to a motor 386 so that the support panel 332 may be rotated by the motor 386, which in turn rotates the lower stone 326. As such, the motor 386 rotates the lower stone 326 about the axis 384 defined by the rod 334. The cooking chamber 322 of the oven portion 306 with its lower and upper stones 326, 327 may also include and be heated by one or more gas flame burners, such as the before-described one more second gas burners 364, that may be positioned below the support panel 332 and the lower stone 326. The oven portion 306 of the cooking station 300 may include structure and features similar to that disclosed in commonly owned U.S. Pat. No. 9,182,129, filed Feb. 20, 2014, entitled “SYSTEM, DEVICE, AND METHOD FOR BAKING A FOOD PRODUCT,” the disclosure of which is incorporated by reference herein in its entirety.

With reference to FIGS. 9, 11, 12, and 13, the main body 302 of the cooking station 300 may extend to define a cabinet type structure with a front side 388, a rear side 390, a first side 392 and a second side 394. The front side 388 may be positioned opposite of the rear side 390 and the first side 392 may be positioned opposite of the second side 394 of the main body 302. Further, the main body 302 may extend with frame components and panels such that the panels of the front and rear sides 388, 390 may extend generally parallel relative to each other and the panels of the first and second sides 392, 394 may extend generally parallel relative to each other. Further, each of the front and rear sides 388, 390 and the first and second sides 392, 394 of the main body 302 may extend between a lower end 396 and the upper surface 312 of the main body 302. Also, the cabinet structure of the main body 302 may extend to define an upper portion 400 and a lower portion 402 thereof. The griddle portion 304 and the oven portion 306 may be supported by the main body 302 and, in some embodiments, may be supported by the upper portion 400 of the main body 302. Further, the gas flame burners for both the griddle portion 304 and the oven portion 306 may be positioned between the front and rear sides 388, 390 within the upper portion 400 of the main body 302. In another embodiment, both the griddle member 310 of the griddle portion 304 and the lower stone 326 of the oven portion 306 may be positioned at a level above the upper surface 312 of the main body 302. As such, the flat griddle cooking surface 314 of the griddle member 310 and the flat stone cooking surface 330 of the lower stone 326 may be positioned at a higher level or above the upper surface 312 of the main body 302.

In another embodiment, the front side 388 of the main body 302 of the cooking station 300 may include gas burner knobs positioned thereon. The gas burner knobs may include one or more first gas burner knobs 336 and one or more second gas burner knobs 338. The one or more first gas burner knobs 336 may correspond with the one or more first gas flame burners 362 that may be solely dedicated to heating the griddle portion 304 of the cooking station 300. The one or more second gas burner knobs 338 may correspond with the one or more second gas flame burners 364 that may be solely dedicated to heating the oven portion 306 of the cooking station 300. As previously set forth, the one or more first and second gas flame burners 362, 364 may feed fuel from separate fuel sources and/or may be employed independently and simultaneously so as to be able to heat the griddle portion 304 and/or the oven portion 306 independently and simultaneously, if desired.

In another embodiment, the main body 302 may include a side shelf 340 on one side of the main body 302, such as the first side 392 and/or the second side 394 of the main body 302. The side shelf 340 may include hooks 342 and a magnetic strip 344 for holding various cooking utensils, for example. Such side shelf 340 may be level with the upper surface 312 of the main body 302. In another embodiment, one side of the main body 302, such as an opposite side of the side shelf 340, may include a pizza peel holder 346. Such pizza peel holder 346 may include openings 348 defined in a horizontally extending structure 350, the openings 348 sized and configured to receive and support a handle of a pizza peel. To assist in the portability of the cooking station 300, the cooking station may include wheels 352 along the lower end 396 or an underside of the main body 302. Further, the pizza peel holder 346 may also incorporate a handle 356 to assist in moving the cooking station 300. In this manner, the cooking station 300 may be readily movable and a portable structure. In another embodiment, the main body 302 may include a tray 358 positioned along one side, such as below the pizza peel holder 346, or along the front side 388 of the main body 302. Such tray 358 may be sized and configured to hold cooking spices or cooking implements or the like. The main body 302 may also include a cabinet like structure with doors 360 that may be opened to access a lower portion 402 of main body 302 of the cooking station 300, which also facilitates accessing the first and second tank openings 368, 370 defined in the bottom panel 366 configured to support first and second propane tanks, for example.

With reference to FIGS. 13 and 16, in another embodiment, the main body 302 may include structure for controlling heat flow between the griddle portion 304 and the oven portion 306 of the cooking station 300. For example, the main body 302 may include a first heat shield 404 and a second heat shield 406 positioned within the upper portion 400 of the main body 302. The first heat shield 404 may be a panel structure that may extend generally horizontally below the one or more first gas burners 362 and above the level of the doors 360 of the cabinet structure of the main body 302. As such, the first heat shield 404 may assist in blocking or minimizing heat flow toward various components of the oven portion 306, such as the motor 386, as well as assist in blocking or minimizing heat flow toward the region holding the propane tanks, accessible via the doors 360, within the lower portion 402 of the main body 302. The second heat shield 406 may include one or more vertically extending panels positioned below the upper surface 312 of the main body and extending toward the level of the first heat shield 404 or to about the level of an upper end of the doors 360 within the upper portion 400 of the main body 302. Further, the second heat shield 406 may extend with multiple panels extending at least partially below the griddle portion 304 and the oven portion 306 such that the second heat shield 406 may extend along a transition between the griddle portion 304 and the oven portion 306 of the cooking station 300. The second heat shield 406 may be sized and configured to further assist in blocking or minimizing heat flow from the first gas burners 362 toward the functional components of the oven portion 306. Furthermore, the first and second heat shields 404, 406 may assist in blocking or minimizing heat flow from the one or more second gas burners 364 of the oven portion 306 toward the griddle member 310. In this manner, the first and second heat shields 404, 406 positioned within the main body 302 may assist in controlling or minimizing heat flow between the griddle portion 304 and the oven portion 306. As such, the cooking station 302 may safely operate with multiple cooking modes for cooking food at two separate locations in a single stand-alone cooking station and at the same time or simultaneously. Further, the cooking station 300 facilitates cooking food in two separate cooking modes on a flat griddle surface 314 as well as a flat stone surface 330 that may each be heated independent of each other and heated simultaneously.

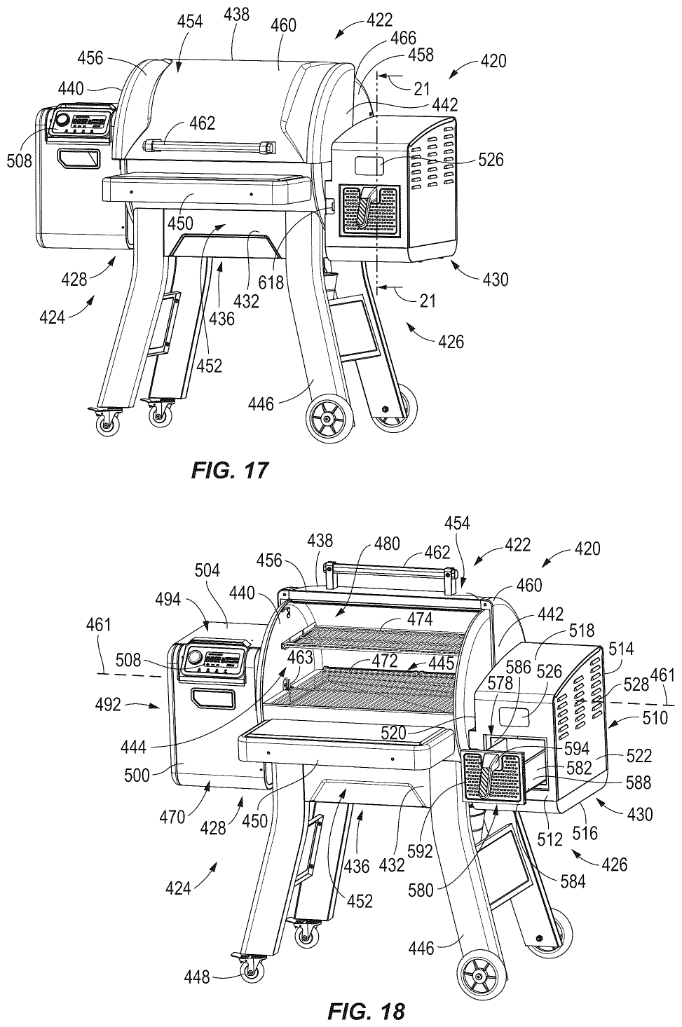

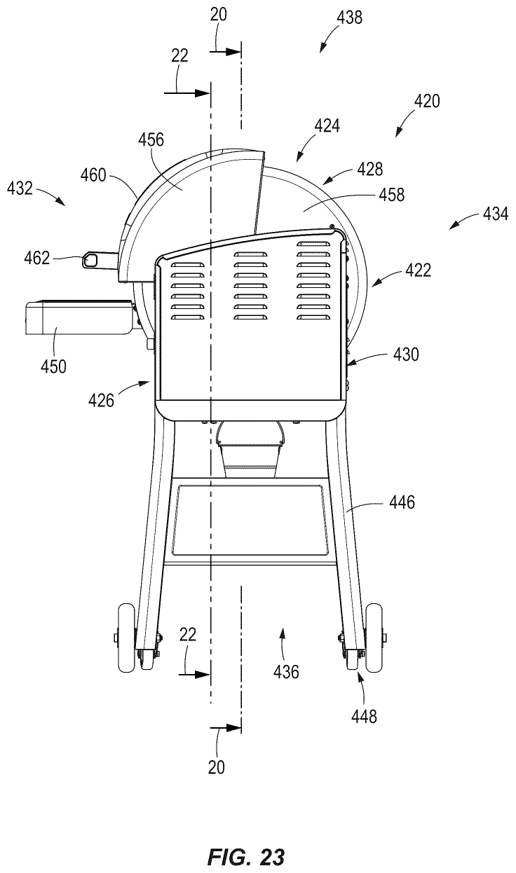

With reference to FIGS. 17-19 and 23, in another embodiment, an outdoor cooking station 420 with multiple independent cooking modes is provided. The outdoor cooking station 420 may include a main body 422 extending to define a first cooking portion 424 and a second cooking portion 426 each of which may define an independent cooking mode that may be independently heated for independently cooking food with distinct locations dedicated for cooking food with the cooking station. Such independent cooking mode may mean that the first and second cooking portions may cook food independent of each other. Further, such first and second cooking portions may be fueled separate and independent of each other and may be employed simultaneously. For example, one cooking mode may be a smoker device 428 defined by the first cooking portion 424 and another cooking mode may be an air fryer device 430 defined by the second cooking portion 426. The main body 422 may extend with similar frame features as provided above in previous embodiments, defining a front side 432, a rear side 434, a bottom side 436, a top side 438, a first side 440, and a second side 442. Further, the main body 422 may extend with panels to define a smoker chamber 444 therein. The first side 440 of the main body 422 may include the first cooking portion 424 and the second side 442 may include the second cooking portion 426, such that, the first cooking portion 424 and second cooking portion 426 may be positioned to extend opposite one another in a side-by-side manner. The main body 422 may include structural elements similar to that described in the previous embodiment, such as, legs 446 and caster wheels 448 extending therefrom. Further, the main body 422 may also include a front shelf 450 coupled to the front side 432, the font shelf 450 sized and configured to provide preparation and/or storage space. In one embodiment, the main body 422 may extend with a rectangular profile. In another embodiment, a lower portion 452 of the main body 422 may extend with a rectangular structure or profile and an upper portion 454 of the main body 422 may extend in a cylindrical structure and/or profile.

The upper portion 454 of the main body 422 having a cylindrical shape or structure may define a forward portion 456 and a rearward portion 458 positioned on the front side 432 and rear side 434 of the main body 422, respectively. The forward portion 456 may be somewhat larger than the rearward portion 458. In this configuration, the forward portion 456 may be configured to slide or pivot over the rearward portion 458 to open the main body 422 into the smoker chamber 444. As such, the forward portion 456 may define a smoker lid 460, which may also be referenced as a hood, door or cover. The smoker lid 460 may rotate or pivot between a closed position and an open position, the open position providing access to the smoker chamber 444. Such smoker lid 460 may rotate about a pivot axis 461 and may rotate over pins 463 positioned axially in ends of the cylindrical structure, the pivot axis extending parallel with a length dimension of the cylindrical structure. When the smoker lid 460 is in the closed position, the smoker chamber 444 may be closed allowing for heat and smoke to be retained therein. The smoker lid 460 may include a smoker handle 462 positioned thereon and configured to be utilized to open and close the smoker lid 460. Further, the smoker lid 460 may also include upper holes 464 located at a seam 466 of the forward portion 456. The seam 466 may extend upwards to define a seam width 468 and be where the forward portion 456 and rearward portion 458 overlap. The upper holes 464 may be positioned to face toward the rear side 434 of the main body 422 and may allow for ventilation of heat and smoke from the smoker chamber 444 towards the rear side 434 of the main body 422, upon the smoker lid 460 being in the closed position.

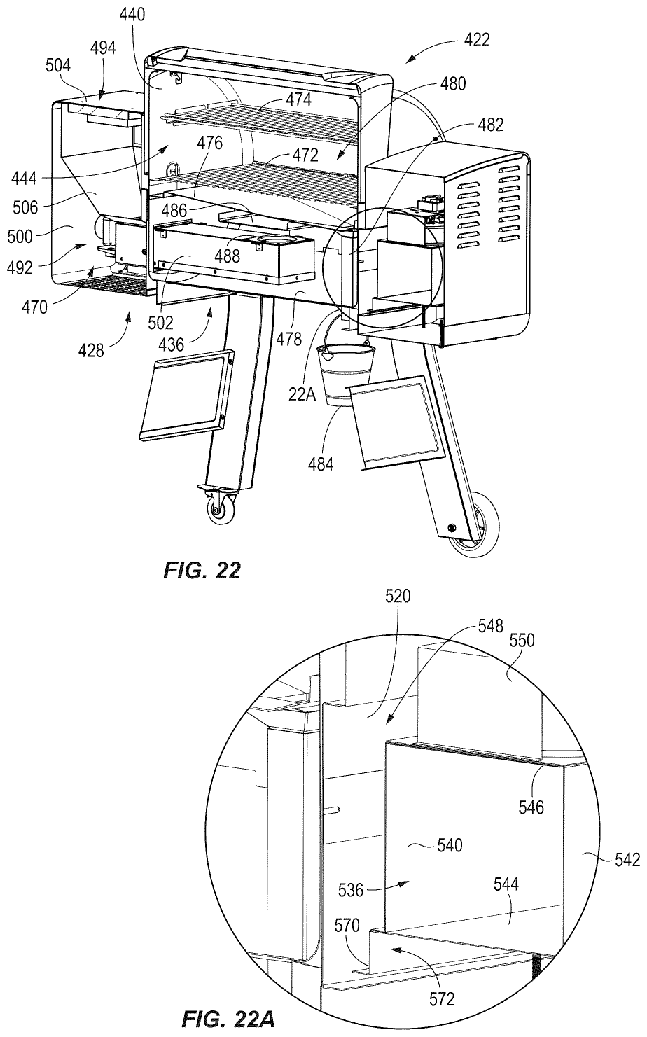

Now, with reference to FIGS. 18, 20, and 22, the smoker device 428 may be implemented in a similar manner as previously described, extending to define a pellet feeder system 470 and the smoker chamber 444. The smoker chamber 444 may include a lower cooking surface 472 and an upper cooking surface 474, where, the lower and upper cooking surfaces 472, 474 may be grates or grill structures that may also include hooks. A grease trough 476 may be positioned below the lower cooking surface 472 and may define a lower smoker portion 478 and an upper smoker portion 480. The grease trough 476 may extend to define a panel that may be sloped so as to extend at an angle towards a grease channel 482. The grease channel 482 may extend in an upright manner within the smoker chamber 444 opposite of the pellet feeder system 470. Further, the grease trough 476 and grease channel 482 may be configured to direct grease and food drippings towards a grease bucket 484 positioned on the bottom side 436 of the main body 422. The smoker device 428 may also include a smoke shield 486 positioned below the grease trough 476 and may be configured to operate similarly as that described above. For example, the smoke shield may shield the upper smoker portion 480 from ash produced by the pellets 489.

The pellet feeder system 470 may be sized and configured to feed pellets 489 to a pellet cup 488 coupled to and/or supporting a first heating element 490, such that, heated smoke 491 may be generated and directed to the smoker chamber 444. Such pellet feeder system 470 may include a housing 492, a pellet hopper 494, a motor 496, an auger 498, the pellet cup 488, and the first heating element 490. The housing 492 may define an upright extending portion 500 and a laterally extending portion 502. The upright extending portion 500 of the housing 492 may be positioned on the first side 440 of the main body 422, where the laterally extending portion 502 may extend from the upright extending portion 500 into the main body 422 or the smoker chamber 444. Similar to the previous embodiment, the upright extending portion 500 of the housing 492 may hold the pellet hopper 494, the motor 496, and a portion of the auger 498. The laterally extending portion 502 of the housing 492 may hold the remaining portion of the auger 498, where, the laterally extending portion 502 and a portion of the auger 498 may extend to the pellet cup 488 and the first heating element 490. The first heating element 490 may be electrically heated, similar to that which is known as a “hot rod” as known to one of ordinary skill in the art. The pellet feeder system 470, including the components associated therewith, may include similar structure and function similarly to the pellet feeder system described in previous embodiments herein. Further, other structures of the pellet feeder system 470, including a housing lid 504, a hopper floor 506, a first control panel 508, and other components of the pellet feeder system may function similar to previous embodiments In addition, the smoker device 470 of this embodiment with its pivoting lid with vent openings defined therein may be similar to the smoker device disclosed in commonly assigned U.S. patent application Ser. No. 17/385,881, filed Jul. 26, 2021, entitled “OUTDOOR COOKING STATION FOR SMOKING FOOD AND METHOD THEREOF”, the disclosure of which is incorporated by reference herein in its entirety.

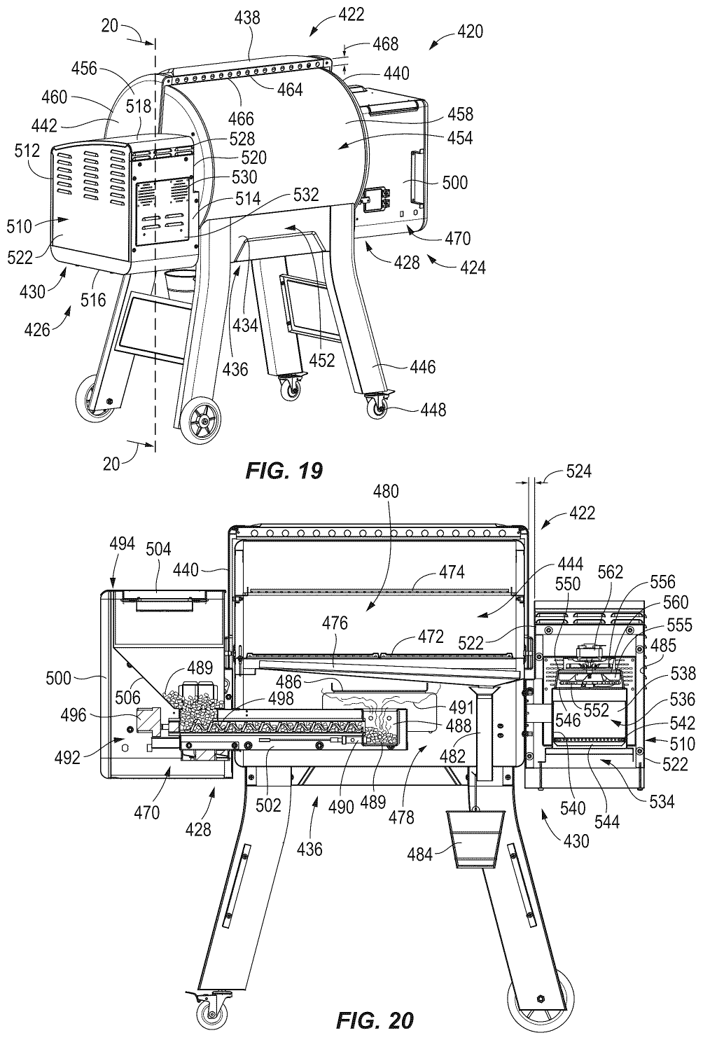

Now with reference to FIGS. 18 and 19, the air fryer device 430 may include an exterior housing 510 defining a front wall 512, a rear wall 514, a bottom wall 516, a top wall 518, a first wall 520, and a second wall 522. In this configuration, the exterior housing 510 may extend in an upright manner, similar to the upright extending portion 500 of the pellet feeder system 470. The air fryer device 430 may be positioned adjacent and coupled to the second side 442 of the main body 422. The first wall 520 of the exterior housing 510 may be positioned adjacent and coupled to the second side 442 of the main body 422. The first wall 520 of the air fryer device 430 and the second side 442 of the main body 422 may define a space 524 (FIG. 20) extending therebetween. The space 524 (FIG. 20) may be an air gap that may be sized and configured to protect the air fryer device 430 and the main body 422 from heating one another. As such heat generated by the smoker device 428 may not affect the air fryer device 430 and vice versa. Further, the space 524 (FIG. 20) may be sized so as to allow for the smoker lid 460 to pivot over the rearward portion 458 of the smoker device 428.

A second control device 526 may be positioned on the exterior housing 510 of the air fryer device 430, such as the front wall 512, that may be configured to control the temperature of the air fryer device 430. The rear wall 514 and second wall 522 of the exterior housing 510 may include exterior vents 528 sized and configured to ventilate air within the air fryer device 430, such as air flow from a fan within the air fryer device 430. The rear wall 514 may also include small vents 530 positioned on a panel 532 of the rear wall 514. The panel 532 may be coupled to the rear wall 514 by screws and may be removable allowing for access into the air fryer device 430.

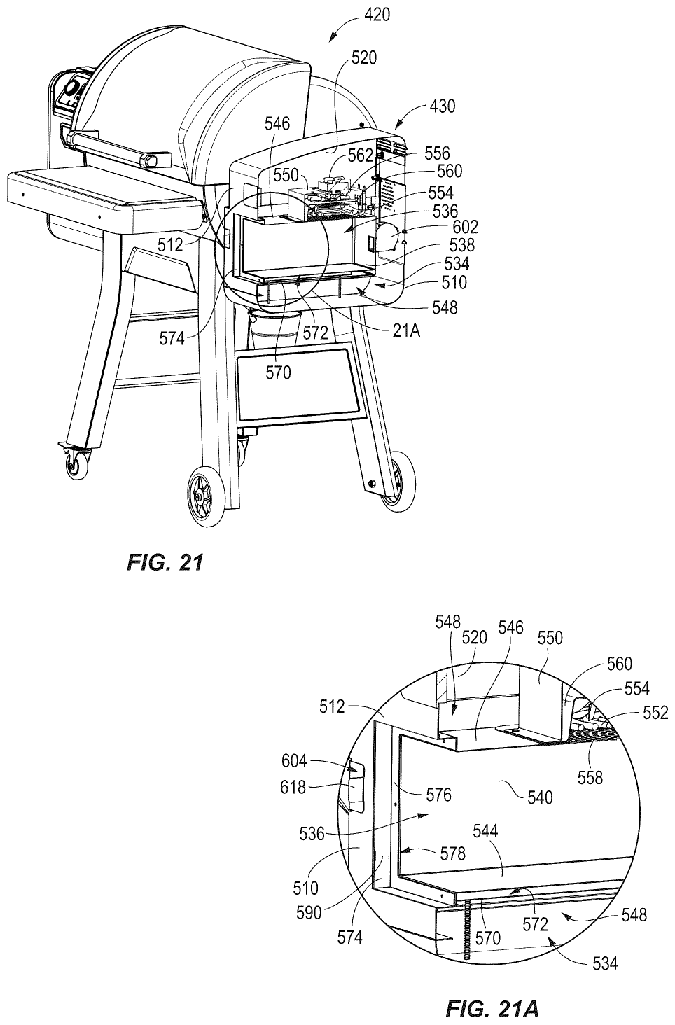

With reference to FIGS. 20-21A, the exterior housing 510 of the air fryer device 430 may extend to define an interior 534 which may include a baking chamber 536 positioned therein. The baking chamber 536 may be defined with a rear chamber wall 538, a left chamber wall 540, a right chamber wall 542, a lower chamber wall 544, and an upper chamber wall 546. The baking chamber 536 may be positioned within the interior 534 of the air fryer device 430 such that an air barrier 548 or air gap is defined between the walls of the baking chamber 536 and the exterior housing 510. The air barrier 548 may be configured to provide a barrier between the heat within the baking chamber 536 and the exterior housing 510. The air fryer device 430 may include an upper housing 550 that may be positioned on the upper chamber wall 546. The upper housing 550 may extend into the air barrier 548. The upper housing 550 may contain or be positioned to at least partially surround a second heating element 552, a lower fan 554, and an upper fan 556 therein. The upper chamber wall 546 may include a burner opening 558 positioned directly below the second heating element 552 such that heat produced from the second heating element 552 may radiate into the baking chamber 536. The lower fan 554 may be positioned directly above the second heating element 552 and may be sized and configured to push air over the second heating element 552 to generate heated air flow from the second heating element 552 and into the baking chamber 536 dispersing the heat therein. The upper housing 550 may extend at least partially to surround a lower fan housing 560. The lower fan housing 560 may extend to at least partially surround or encase the second heating element 552 and the lower fan 554 such that one side may be open so heated air may move into the baking chamber 536 from the second heating element 552 disposed within the second lower fan housing 560. The upper housing 550 may extend to partially surround or contain the lower fan housing 560 where the upper fan 556 may be positioned above the lower fan housing 560. The upper fan 556 may be sized and configured to blow air onto a fan motor 562 positioned above the upper fan 556 and the upper housing 550 so that the fan motor 562 may stay cool. The second control panel 526 may include components sized and configured to control the fan motor 562 as well as the lower and upper fans 554, 556. In a further embodiment, the fan motor 562 may be positioned within the upper housing 550 above the upper fan 556.

With reference to FIGS. 20, 21-21A and 22A, the rear, left, right, lower, and upper chamber walls 538, 540, 542, 544, 546 of the baking chamber 536 may be configured to maintain the heat produced by the second heating element 552. As such, upon the rear, left, right, lower, and upper chamber walls 538, 540, 542, 544, 546 being heated, such walls may radiate heat therefrom and within the baking chamber 536. The baking chamber 536 may also include a lower chamber floor 570 positioned below the lower chamber wall 544 defining a lower space 572 therebetween. The lower space 572 may provide further structure and stability to the baking chamber 536 such that the lower chamber floor 570 may be coupled to the first and second wall 520, 522 of the exterior housing 510 of the air fryer device 430. In this configuration, the lower chamber floor 570 may provide structure and stability to the walls of the baking chamber 536.

As previously set forth, the exterior housing 510 may extend to encase or at least partially surround the baking chamber 536 and the upper housing 550 to provide the air barrier 548 which may facilitate substantially preventing the exterior housing 510 from overheating. The front wall 512 of the exterior housing 510 may extend to define a front frame 574 inset into the front wall 512. The front frame 574 may extend perpendicular to the front wall 512 of the exterior housing 510 and may be coupled to a chamber frame 576. The chamber frame 576 may extend parallel to the front wall 512 of the exterior housing 510 and be coupled to the left, right, lower, and upper chamber walls 540, 542, 544, 546 of the baking chamber 536. Further, the chamber frame 576 may define a chamber opening 578 therein.

Now with reference to FIGS. 18 and 21A, the chamber opening 578 may be sized and configured for an insert 580 to be positioned therein. The insert 580 may include a basket 582 and a front barrier 584. The basket 582 may be sized and configured to fit within the baking chamber 536 such that the basket 582 may not come into contact with the rear, left, right, lower, and upper chamber walls 538, 540, 542, 544, 546. As such, a periphery space 586 may be defined between the basket 582 and the rear, left, right, lower, and upper chamber walls 538, 540, 542, 544, 546 of the baking chamber 536. The periphery space 586 may allow for heat to circulate throughout the baking chamber 536 between the basket 582 and the rear, left, right, lower, and upper chamber walls 538, 540, 542, 544, 546. The basket 582 of the insert 580 may define panels 588, or, in a further embodiment, the panels 588 may extend with multiple perforations. As such, the panels 588 of the basket 582 may extend to define perforations or may extend to define wire like walls or may include some panels with perforations and some wire like walls to form the basket 582. With this arrangement, the basket 582 may be sized and configured to facilitate circulating heat through the basket 582.

The insert 580 may be positioned within the baking chamber 536 by inserting the basket 582 into the chamber opening 578 and pushing the insert 580 in ward or laterally towards the rear chamber wall 538 (FIG. 20) of the baking chamber 536. When the insert 580 is positioned in the baking chamber 536, the front barrier 584 or wall associated with the basket 582 may be sized and configured to fit and rest on the front frame 574 of the exterior housing 510. The front barrier 584 may include a width 590 extending perpendicular to the front barrier 584 and may be configured to provide distance between the front barrier 584 and the heat located within the basket 582 and the baking chamber 536. Further, the width 590 may extend similar to that of the front frame 574, such that, with the insert 580 positioned in the baking chamber 536, the front barrier 584 may extend flush relative to the front wall 512 of the exterior housing 510 and may completely close off the chamber opening 578. The front barrier 584 may also include multiple front openings 592 configured to allow for cool air to flow within the width 590 of the front barrier 584, and therefore, between the heat surrounding the basket 582 and flowing throughout the baking chamber 536. In this configuration, the front barrier 584 may be protected from the heat within the baking chamber 536. The front barrier 584 may also include a grip 594 sized and configured to be utilized to remove the insert 580 from the baking chamber 536. When the insert 580 may be positioned in the baking chamber 536, the front barrier 584 of the insert 580 may come into contact with the chamber frame 576 and the front frame 574.

With reference to FIGS. 17 and 20, as previously stated, the smoker device 428 and the air fryer device 430 may include the first control panel 508 and the second control panel 526 respectively. The first and second control panels 508, 526 may be touch sensitive displays that may be configured to control the first heating element 490 and the second heating element 552 respectively. The first heating element 490 may be a pellet burner element. In another embodiment, the first heating element 490 may be a gas fueled burner which may ignite the pellets 489 in the pellet cup 488. In another embodiment, the first heating element 490 maybe an electric burner configured to ignite the pellets 489 in the pellet cup 488. The electric burner may be a “hot rod” type electric burner. In another embodiment, the first heating element 490 may employ both the electric burner and the gas fueled burner. The second heating element 552 may be an electric burner configured to radiate heat into the baking chamber 536 of the air fryer device 430. With the second heating element generating heat, the lower fan 554 may move air over the second heating element to move air into the baking chamber 536 to air fry food positioned within the basket 582 of the air fryer device 430. In this manner, the cooking station 420 may include first and second cooking portions 424, 426 sized and configured to cook food independent of each other and with independent fuel sources.

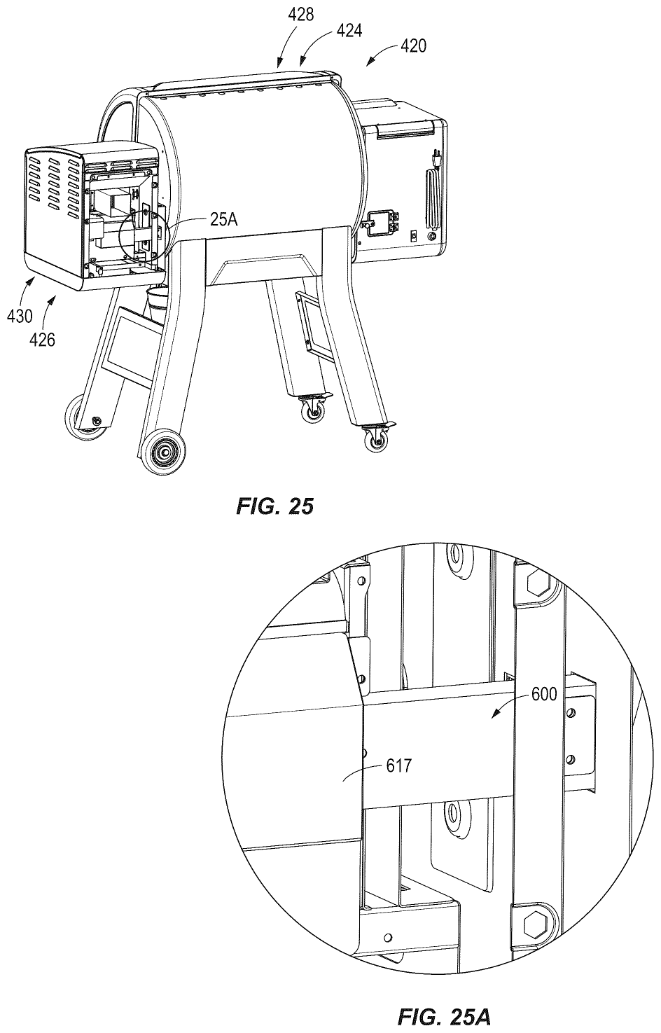

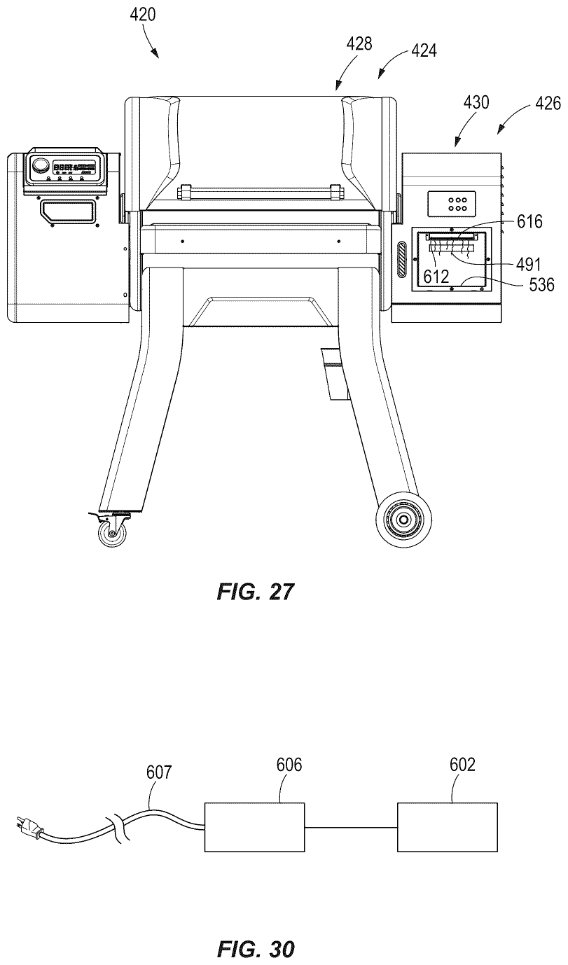

Now with reference to FIGS. 18, 21, 21A, 24, 24A, 25, 25A, 26, 26A, 27 and 30, another embodiment directed to the first cooking portion 424 (or smoker device 428) and the second cooking portion 426 (or air frying device 430) of the cooking station 420 is provided. In this embodiment, the cooking station 420 may be sized and configured to facilitate cold smoking within the air fryer chamber 536. For example, the cooking station 420 may include ducting 600 extending from the smoker chamber 444 to the air fryer chamber 536 and a motor fan 602. In another embodiment, the ducting 600 may be associated with a blocker component 604 and an electrical switch 606, the electrical switch 606 extending between a power plug 607 and the motor fan 602. Such ducting 600 may extend to define an air way or passage 609 between the smoker chamber 444 and the air fryer chamber 536. As such, the ducting 600 may extend between first and second ends 610, 612, the first end 610 positioned adjacent the smoker chamber 444 and the second end 612 positioned adjacent the air fryer chamber 536. The first end 610 of the ducting may define a first opening 614 defined in a wall of the smoker chamber 444. The second end 612 of the ducting 600 may define a second opening 616 defined in a wall of the air fryer chamber 536 (see FIG. 27).

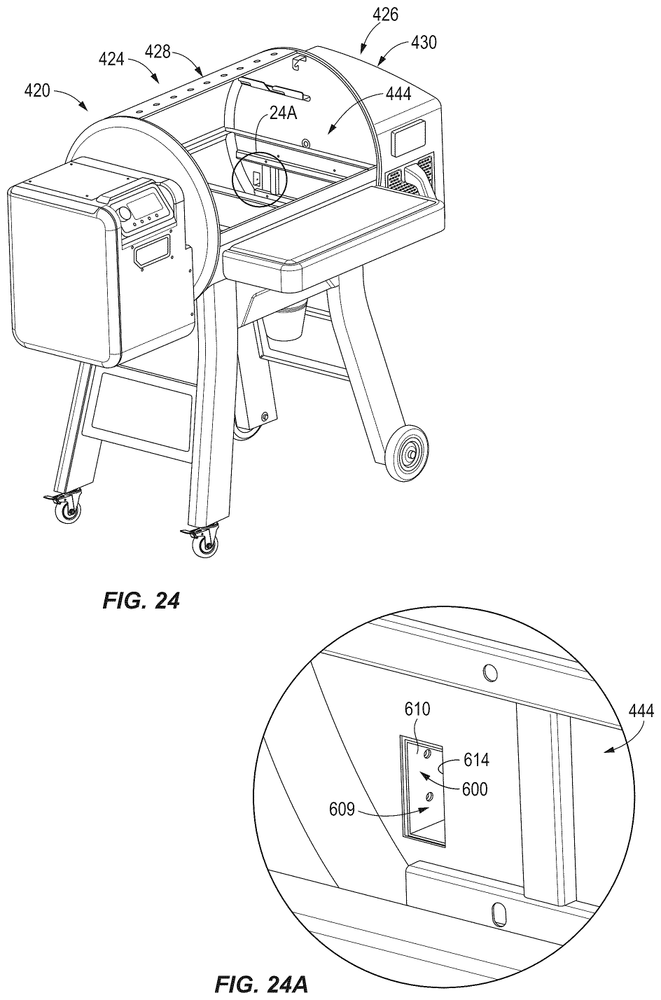

As depicted in FIGS. 24A, 25, 25A, 26, 26A and 27, the ducting 600 may extend with one or more ducting components between the first and second ends 610, 612 of the ducting 600. For example, the ducting 600 may include a large ducting portion 617 along a rear side of the air fryer device 430 that may at least partially house the motor fan 602. Such motor fan 602 may be sized and configured to draw air from the smoker chamber 444 and push air into the air frying chamber 536. Upon generating smoke 491 (FIG. 20) in the smoker chamber 444, the motor fan 602 may be activated to draw smoke from the smoker chamber 444, through the ducting 600, to be pushed by the motor fan 602 into the air fryer chamber 536 or a secondary chamber relative to the smoker chamber 444. As depicted in FIG. 27, the smoke may be pushed through the second opening 616 defined in one or more walls of the air frying chamber 536. In this manner, the smoker chamber 444 and the air frying chamber 536 (or a secondary chamber) may be interconnected by the ducting 600 extending therebetween.

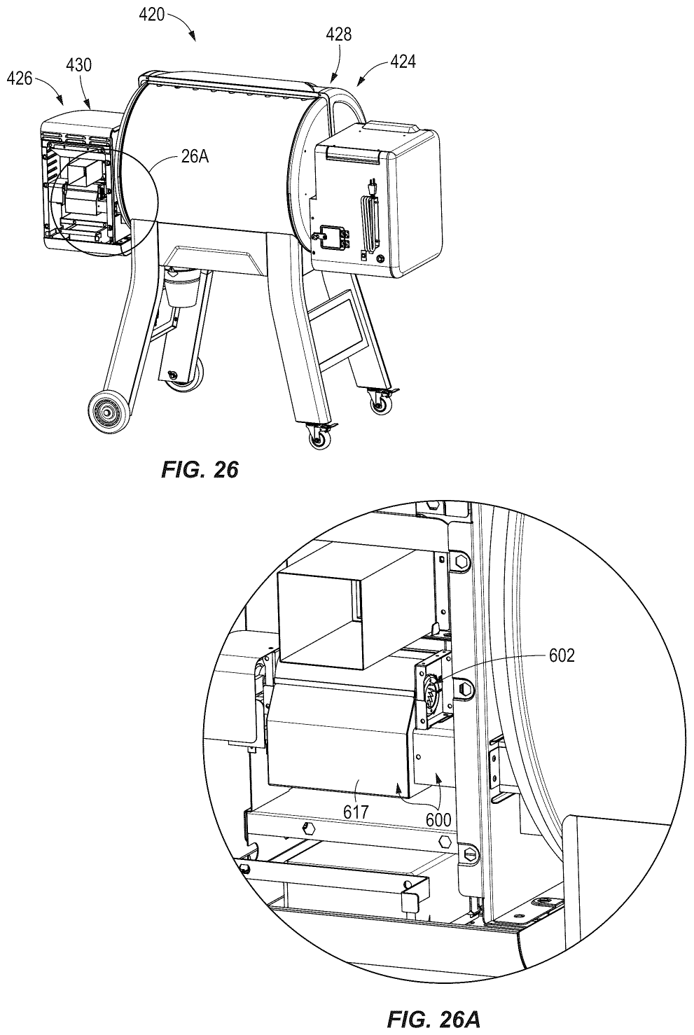

With reference to FIGS. 18, 28A, 28B, 29A, 29B and 30, as previously set forth, the air frying chamber 536 may be employed as a secondary chamber relative to the smoker chamber 444 for cold smoking food therein. As such, the air fryer chamber 536 may be referenced as a secondary chamber or a secondary smoker chamber. The air fryer chamber 536 may be employed as the secondary smoker chamber by activating the motor fan 602 (see also, FIG. 26A). Further, the motor fan 602 may be activated by moving the blocking component 604. The blocking component 604 may extend with a linkage 620 that may be manually moveable with a handle 618 or tab (see also, FIG. 21A) between a first tab position and a second tab position. The handle 618 may be exposed along an exterior surface 622 of the air fryer device 430. In the first tab position, the linkage 620 of the blocking component 604 may be positioned to block the passage 609 of the ducting 600 so that the handle 618 may be positioned adjacent to the exterior surface 622 of the air fryer device 430. Also, in the first tab position, the linkage 620 may be moved to a position such that a connection piece 608 of the switch 606 may be separated from a conductor 624 of the switch 606 so that a circuit of the switch 606 is open and so that current cannot flow through the switch 606. In one embodiment, the linkage 620 may define a notch 626 or recess therein that may facilitate the separation of the connection piece 608 and the conductor 624 of the switch 606. In the second tab position, the handle 618 may be manually pulled away from, and relative to, the exterior surface 622 of the air fryer device 430. Further, in the second tab position, the connection piece 608 may be moved to contact the conductor 624 to close the electrical circuit of the electrical switch 606 so that the motor fan 602 may be activated to push and draw air or smoke from the smoker chamber 444, through the ducting 600, and into the secondary smoker chamber or air fryer chamber 430.

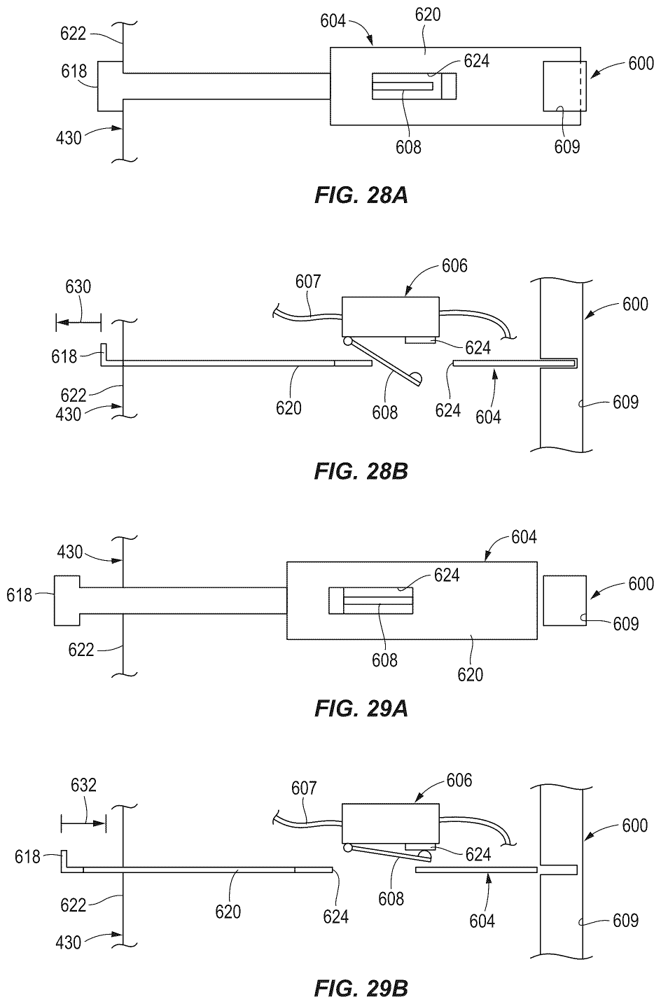

In one embodiment, a method for employing the secondary smoker chamber or air fryer chamber 536 of the cooking station 420 will now be described. For example, the first cooking portion 424 or smoker chamber 444 may be heated by a user by igniting pellet elements 489 (FIG. 20) as the fuel source to generate smoke 491 (FIG. 20) within the smoker chamber 444, similar to that described herein in previous embodiments. If desired, the user may position food items on a cooking surface, such as a grill portion 445, within the smoker chamber 444 so that the food items may be exposed to the smoke and heat within the smoker chamber 444. If the user wants to cold smoke a food item, such as cheese, the user can position the food item within the basket 582 and then position the basket 582 within the secondary chamber or the air frying chamber 536. The user may then pull the handle 618 (see also, FIG. 17) from the first tab position to the second tab position, as depicted by arrow 630, in FIG. 28B. Once the handle 618 is moved to the second tab position, the blocking component 604 may be removed from the ducting 600 (see FIGS. 28A and 29A). Also, upon the blocking component 604 being removed from the ducting 600, the connection piece 608 of the electrical switch 606 may move so that the connection piece 608 engages the conductor 624 of the switch 606 (see FIG. 29B). Such engagement of the connection piece 608 with the conductor 624 closes the switch to provide the electrical connection so that current may pass from the power cord 607, through the switch 606 and to the motor fan 602 (see FIG. 30). As such, movement of the blocking component 604 to the second tab position may be configured to activate the motor fan 602. Upon activating the motor fan 602, the motor fan 602 may draw smoke 491 (FIG. 20) from the smoker chamber 444, through the ducting 600, and into the secondary smoker chamber or air fryer chamber 536 so that the food item in the basket 582, such as cheese, may be exposed to the smoke 491 (FIG. 27) drawn therein. In this manner, the secondary chamber 536 may be employed for cold smoking a food item, while also cooking food with the smoker device 428. In another embodiment, the air fryer chamber 536 may be employed to air fry food therein with the activated electrical element or second heating element 552 and lower fan 554 (see FIG. 20) positioned along an upper side of the air fryer chamber 536, while also drawing smoke 491 into the air fryer chamber 536 (through the second opening 616 (FIG. 27)) so that the air frying of the food item includes exposing the food item to smoke 491 funneled therein. In still another embodiment, if a user desires to close-off the smoke from the smoker chamber 444, the user may do so by moving the handle 618 from the second tab position to the first tab position, as shown by arrow 632 in FIG. 29B. Such movement may move the handle 618 adjacent the exterior surface 622 of the air fryer device 430, which moves the blocking component 604 into a space defined in the ducting 600 to block air flow therethrough (see FIGS. 28A, 28B). Such movement also breaks the electrical connection of the switch 606 so that the connection piece 608 may be separated from the conductor 624 of the switch 606. In this manner, the motor fan 602 may be deactivated by simply moving the handle 618 to the first tab position, as previously set forth. Such deactivation of the motor fan 602 also may result in the ducting 600 being blocked by the blocking component 604. Further, such deactivation of the motor fan 602 may be implemented while heating the air fryer chamber 536 with the electrical burner or second heating element 552 (FIG. 20).

As set forth herein, in one embodiment, the cooking station 420 may be employed for cooking food at two separate distinct locations, with two distinct cooking modes, each of the separate locations dedicated to cook food simultaneously and independent of each other with the different cooking modes. For example, one cooking mode of the cooking station 420 may be to use pellet elements 489 to generate smoke 491 (FIG. 20) to smoke and grill food on a grill within the smoker chamber 444, and another cooking mode may be for cooking food by air frying the food within an air frying chamber 536. In another embodiment, the cooking station 420 may be employed for smoking food at two separate locations, one location within a first chamber or smoker chamber 444 for grilling and smoking food therein and, another location within a second chamber or a second smoker chamber (the air fryer chamber 536) that may receive smoke 491 from the first chamber 444. In still another embodiment, the cooking station 420 may be employed for cooking food at two separate distinct locations, such as the smoker chamber 444 and the air frying chamber 536, with the two distinct cooking modes, each of the separate locations dedicated to cook food simultaneously (if desired) with the two distinct cooking modes, while also funneling smoke 491 from the smoker chamber 444 via the ducting 600 to the air frying chamber 536 to provide a smokey flavor to the food being cooked with the second heating element 552 in the air frying chamber 536.

The various structural components of the various embodiments of the cooking stations disclosed herein and any other structural components thereof may be formed of various metallic materials, such as steel, stainless steel, copper, aluminum or any other suitable material with high temperature ratings, such as various suitable polymeric materials, and may be formed from known structural components, such as sheet metal at various gauges/thicknesses or other known metallic structures, such as tubing or the like, and may be formed and manufactured through various known processes and techniques known in the art, such as casting, welding, rolling, bending, pressing, fastening, etc., as known by one of ordinary skill in the art. In addition, the griddle member 310 may be manufactured from metallic materials, such as, carbon steel, cast iron, stainless steel, or aluminum, or various metal alloys, or even the composite layering of materials, or any other suitable cooking surface material known in the art, such as porcelain coated materials. Further, in some embodiments, the metallic material of the griddle member may be manufactured using cold rolled steel processes, or hot rolled steel techniques, or any other known manufacturing process, such as casting or stamping, as known in the art. The various plate components of the griddle member 310 may include a thickness of 5-6 millimeters, but is not so limited, as such thickness of the various components of the griddle member may range, for example, between 4-10 millimeters. Furthermore, in embodiments employing a “stone” within a cooking portion described herein may be a term of art for “a pizza stone” and may be formed from a ceramic material, a cordierite material and/or a composite material or combinations/blends thereof.

While the invention may be susceptible to various modifications and alternative forms, specific embodiments have been shown by way of example in the drawings and have been described in detail herein. Further, the structural features of any one embodiment disclosed herein may be combined or replaced by any one of the structural features of another embodiment set forth herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. An outdoor cooking station configured to independently cook food with different cooking modes and with separate fuel sources, one of the cooking modes configured to burn pellet elements to produce heated smoke, the outdoor cooking station comprising:
a main body extending to define a first cooking portion and a second cooking portion for cooking in the different cooking modes, the first cooking portion and the second cooking portion being separate so as to be configured to be dedicated to cooking food simultaneously and independent of each other with the different cooking modes, the first cooking portion including a smoker chamber with a grill cooking surface suspended therein, and including a pellet burner element positioned below the smoker chamber and configured to supply heated smoke to the smoker chamber, the second cooking portion of the main body extending to define an air frying chamber, the air frying chamber being accessible with a removable insert having a basket therewith such that the basket is sized to be positioned within the air frying chamber, the second cooking portion including a heating element and a fan positioned adjacent the heating element, the fan configured to move air over the heating element to mix air within the air frying chamber to facilitate cooking food placed within the basket of the insert; and
a pellet feeder system coupled to the first cooking portion of the main body, the pellet feeder system including a hopper and a feeder, the hopper defining an opening adjacent a lower end of the hopper and the hopper configured to hold the pellet elements, the feeder positioned adjacent the opening defined in the hopper such that the feeder is configured to rotate so as to deliver the pellet elements from the opening defined in the hopper to a pellet cup so that the pellet elements are positioned adjacent the pellet burner element of the first cooking portion of the main body.

2. The outdoor cooking station of claim 1, wherein the pellet burner element of the first cooking portion comprises an electrical heating element positioned within the pellet cup sized and configured to ignite pellet elements with a fan positioned adjacent the feeder to further ignite the pellet elements.

3. The outdoor cooking station of claim 1, wherein the heating element of the second cooking portion comprises an electrical heating element positioned adjacently below the fan.

4. The outdoor cooking station of claim 1, wherein the first cooking portion comprises a smoke shield positioned over the pellet cup.

5. The outdoor cooking station of claim 1, wherein the first cooking portion and the second cooking portion of the main body are positioned to define a spaced gap therebetween.

6. The outdoor cooking station of claim 1, wherein the first cooking portion comprises a lid pivotably moveable between a closed position and an open position, wherein, upon the lid being in the closed position, the lid defines vent openings therein positioned along a rear side of the lid, the vent openings configured to vent smoke from the smoker chamber.

7. The outdoor cooking station of claim 1, wherein the second cooking portion comprises a housing and chamber walls, the chamber walls configured to at least partially surround and define the air frying chamber, the housing extending to at least partially surround the chamber walls to define an air gap between the housing and the chamber walls.

8. The outdoor cooking station of claim 1, wherein the first cooking portion of the main body extends to at least partially define a cylindrical structure, the cylindrical structure defining an axis that extends through a pivot point of a lid of the first cooking portion.

9. The outdoor cooking station of claim 1, wherein the main body comprises ducting and a motor fan, the ducting extending between the smoker chamber and the air fryer chamber such that the motor fan is configured to draw smoke from the smoker chamber to the air fryer chamber.

10. The outdoor cooking station of claim 9, wherein the motor fan is activated with movement of a linkage from a first position to a second position, wherein, upon the linkage being moved to the second position, a portion of the linkage is removed from the ducting to facilitate air flow therethrough and a portion of the linkage triggers a connection piece of a switch to electrically activate the motor fan.

11. An outdoor cooking station configured to independently cook food with different cooking modes and with separate fuel sources, one of the cooking modes configured to burn pellet elements to produce heated smoke, the outdoor cooking station comprising:
a main body extending to define a first cooking portion and a second cooking portion for cooking in the different cooking modes, the first cooking portion and the second cooking portion being separate so as to be configured to be dedicated to cooking food simultaneously and independent of each other with the different cooking modes, the first cooking portion including a smoker chamber with a grill cooking surface suspended therein, and including an electrical pellet burner element positioned below the smoker chamber and configured to supply heated smoke to the smoker chamber, the second cooking portion of the main body extending to define an air frying chamber, the air frying chamber being accessible with a removable insert having a wall and a basket, the basket coupled to one side of the wall and a grip positioned on another side of the wall, the wall of the insert positioned within an opening of the air frying chamber such that the basket is sized to be positioned within the air frying chamber, the second cooking portion including a heating element and a fan positioned adjacent the heating element, the fan configured to move air over the heating element to mix air within the air frying chamber to facilitate cooking food placed within the basket of the insert; and
a pellet feeder system coupled to the first cooking portion of the main body, the pellet feeder system including a hopper and a feeder, the hopper defining a hopper opening adjacent a lower end of the hopper and the hopper configured to hold the pellet elements, the feeder positioned adjacent the hopper opening defined in the hopper such that the feeder is configured to rotate so as to deliver the pellet elements from the hopper opening defined in the hopper to a pellet cup within the first cooking portion so that the pellet elements are positioned adjacent the electrical pellet burner element of the first cooking portion of the main body.

12. The outdoor cooking station of claim 11, wherein the first cooking portion comprises a smoke shield positioned over the pellet cup.

13. The outdoor cooking station of claim 11, wherein the first cooking portion and the second cooking portion of the main body are positioned to define a spaced gap therebetween.

14. The outdoor cooking station of claim 11, wherein the second cooking portion comprises a housing and chamber walls, the chamber walls configured to at least partially surround the air frying chamber, the housing extending to at least partially surround the chamber walls to define an air gap between the housing and the chamber walls.

15. The outdoor cooking station of claim 11, wherein the first cooking portion comprises a lid pivotably moveable between a closed position and an open position, wherein, upon the lid being in the closed position, the lid defines vent openings therein positioned along a rear side of the lid, the vent openings configured to vent smoke from the smoker chamber.

16. The outdoor cooking station of claim 11, wherein the first cooking portion of the main body extends to at least partially define a cylindrical structure, the cylindrical structure defining an axis that extends through a pivot point of the lid.

17. The outdoor cooking station of claim 11, wherein the main body comprises ducting and a motor fan, the ducting extending between the smoker chamber and the air fryer chamber such that the motor fan is configured to draw smoke from the smoker chamber to the air fryer chamber.

18. The outdoor cooking station of claim 17, wherein the motor fan is activated with movement of a linkage from a first position to a second position, wherein, upon the linkage being moved to the second position, a portion of the linkage is removed from the ducting to facilitate air flow therethrough and a portion of the linkage triggers a connection piece of a switch to electrically activate the motor fan.

19. A method for cooking food in the outdoors, the method comprising:
providing an outdoor cooking station with a main body extending to define a first cooking portion and a second cooking portion, the first cooking portion and the second cooking portion being separate so as to be dedicated to cooking food simultaneously and independent of each other with different cooking modes, the first cooking portion including a smoker chamber and the second cooking portion including an air frying chamber, the second cooking portion including a heating element and a fan for heating the air frying chamber, the main body including a pellet feeder system coupled thereto for heating the smoker chamber with pellet elements, the pellet feeder system including a hopper and a feeder, the hopper sized and configured to hold pellet elements therein and to be moved therefrom by the feeder;
opening a door to the smoker chamber of the first cooking portion to position food on a grill cooking surface suspended within the smoker chamber and then closing the door to enclose the food within the smoker chamber;
positioning other food in a basket of a removable insert to then position the basket within the air frying chamber;
feeding the pellet elements from a hopper opening defined in a lower end of the hopper with rotation of the feeder to deliver the pellet elements to a pellet cup positioned in the first cooking portion and adjacent a pellet burner element;
heating the smoker chamber by burning the pellet elements with a pellet burner element to generate smoke so that heated smoke moves into the smoker chamber to heat the food on the grill cooking surface; and
heating the air frying chamber with the heating element and the fan such that the fan moves air over the heating element and mixes the heated air in the air frying chamber for cooking the other food in the basket.

20. The method according to claim 19, wherein the providing comprises providing ducting and a motor fan, the ducting extending between the smoker chamber and the air fryer chamber such that the motor fan is configured to draw smoke from the smoker chamber to the air fryer chamber.

21. The method according to claim 20, further comprising activating the motor fan by moving a linkage from a first position to a second position so that a portion of the linkage is removed from the ducting to facilitate air flow through the ducting.

22. The method according to claim 21, wherein the activating the motor fan comprises triggering a connection piece of a switch with the linkage so that the connection piece of the switch electrically engages a conductor of the switch to electrically activate the motor fan.

23. An outdoor cooking station configured to independently cook food with different cooking modes and with separate fuel sources, one of the cooking modes configured to burn pellet elements to produce heated smoke, the outdoor cooking station comprising:
a main body extending to define a first cooking portion and a second cooking portion for cooking in the different cooking modes, the first cooking portion and the second cooking portion being separate so as to be configured to be dedicated to cooking food simultaneously and independent of each other with the different cooking modes, the first cooking portion including a smoker chamber with a grill cooking surface suspended therein, and including a pellet burner element positioned below the smoker chamber and configured to supply heated smoke to the smoker chamber, the second cooking portion of the main body extending to define a secondary cooking chamber, the secondary cooking chamber including a heating element positioned therein for heating the secondary cooking chamber, the main body including ducting extending between the smoker chamber and the secondary cooking chamber with a motor fan positioned adjacent to the ducting; and
a pellet feeder system coupled to the first cooking portion of the main body, the pellet feeder system including a hopper and a feeder, the hopper defining an opening adjacent a lower end of the hopper and the hopper configured to hold the pellet elements, the feeder positioned adjacent the opening defined in the hopper such that the feeder is configured to rotate so as to deliver the pellet elements from the opening defined in the hopper to a pellet cup so that the pellet elements are positioned adjacent the pellet burner element of the first cooking portion of the main body;
wherein, upon the pellets being ignited to generate smoke within the smoker chamber and upon the motor fan being activated, the motor fan is configured to draw smoke from the smoker chamber to move through the ducting and into the secondary cooking chamber.

24. The outdoor cooking station of claim 23, wherein the motor fan is activated with movement of a linkage from a first position to a second position, wherein, upon the linkage being moved to the second position, a portion of the linkage is removed from the ducting to facilitate air flow therethrough and a portion of the linkage triggers a connection piece of a switch to electrically activate the motor fan.

25. The outdoor cooking station of claim 23, wherein the secondary cooking chamber comprises a fan positioned adjacent the heating element, the fan configured to move air over the heating element and to mix air within the secondary cooking chamber to facilitate cooking food within the secondary cooking chamber.
